(19) United States
(12) Patent Application Publication
(10) Pub. No.: US 2017/0295472 A1
(43) Pub. Date: Oct. 12, 2017

(54) COMMUNICATION APPARATUS, DETECTION METHOD, AND COMMUNICATION SYSTEM

(71) Applicant: FUJITSU LIMITED, Kawasaki-shi (JP)

(72) Inventor: Yasushi Hara, Kunitachi (JP)

(73) Assignee: FUJITSU LIMITED, Kawasaki-shi (JP)

(21) Appl. No.: 15/439,223

(22) Filed: Feb. 22, 2017

(30) Foreign Application Priority Data
Apr. 8, 2016 (JP) 2016-077883

(51) Int. Cl. H04W 4/06; H04W 24/08

(52) U.S. Cl. CPC H04W 4/06; H04W 24/08

(57) ABSTRACT

A communication apparatus executes a determination process that includes measuring an intensity of a first radio wave received from a first relay in accordance with a first wireless communication method, receiving, from the first relay, an entering notification having an intensity range in which the communication apparatus under a certain situation is to receive the first radio wave from the first relay apparatus, and deciding that communication is possible with a second relay in accordance with a second wireless communication method when the measured intensity of the first radio wave from the first relay indicates a value within the intensity range indicated by the notification, and executes an initiation process that includes starting, when the processor decides that communication is possible with the second relay, detection of a second radio wave from the second relay.

### CROSS-REFERENCE TO RELATED APPLICATION

This application is based upon and, claims the benefit of priority of the prior Japanese Patent Application No. 2016-077883, filed on Apr. 8, 2016, the entire contents of which are incorporated herein by reference.

### FIELD

The present technologies relate to a communicommunication apparatus, a detection method and a communication system.

### BACKGROUND

Wireless gigabit (Wi-Gig) is a communication standard that uses a millimeter wave, for example, of 60 GHz. Wi-Gig makes it possible to perform high-speed wireless transmission of, for example, 7 Gbps. Therefore, Wi-Gig allows transmission of a large amount of data, for example, of a movie file for high definition television broadcasting or of a movie file for super high vision broadcasting in the form of non-compressed data. Also, the communicable distance of a Wi-Gig access point is, for example, approximately 10 m where beam forming is used. Examples of the related art include Japanese National Publication of International Patent Application No. 2008-508832, Japanese National Publication of International Patent Application No. 2013-505662, and Japanese Laid-open Patent Publication No. 2012-205253.

### SUMMARY

According to an aspect of the embodiments, a communication apparatus includes: a memory; and processor coupled to the memory and configured to execute a determination process that includes measuring an intensity of a first radio wave received from a first relay apparatus that transmits the first radio wave in accordance with a first wireless communication method, receiving, from the first relay apparatus, an entering notification having setting information indicative of an intensity range in which the communication apparatus under a certain situation is to receive the first radio wave, and deciding that communication is possible with a second relay apparatus that transmits a second radio wave in accordance with a second wireless communication method when the measured intensity of the first radio wave received from the first relay apparatus indicates a value within the intensity range indicated by the setting information, and execute an initiation process that includes starting, when the processor decides that communication is possible with the second relay apparatus, detection of the second radio wave from the second relay apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view depicting an example of an exemplary communication system;

FIG. 2 is a block diagram exemplifying a configuration of a communication system according to embodiments;

FIG. 3 is a sequence diagram exemplifying a sequence of a communication coupling process according to a first embodiment;

FIG. 4 is a view exemplifying a relationship between a radio wave of a wireless fidelity (Wi-Fi) access point and a Wi-Gig communication area;

FIG. 5 is a view exemplifying radio wave intensity management information according to the embodiment;

FIG. 6 is aview exemplifying portable terminal information according to the embodiment;

FIG. 7 is a flow chart exemplifying a Wi-Gig direction entering flag setting process of a portable terminal according to the first embodiment;

FIGS. 8A and 8B are a flow chart exemplifying a communication coupling process of a portable terminal according to the first embodiment;

FIG. 9 is a flow chart exemplifying a Wi-Fi communication coupling process of a Wi-Fi access point according to the first embodiment;

FIG. 10 is a sequence diagram exemplifying a sequence of a communication coupling process according to a second embodiment;

FIG. 11 is a flow chart exemplifying a Wi-Gig direction entering flag setting process of a portable terminal according to the second embodiment;

FIGS. 12A and 12B are a flow chart exemplifying a communication coupling process of a portable terminal according to the second embodiment;

FIG. 13 is a view exemplifying a download reservation notification according to the second embodiment;

FIG. 14 is a flow chart exemplifying a file transmission process of a controller according to the second embodiment;

FIG. 15 is a flow chart exemplifying a file transmission process of a Wi-Gig access point according to the second embodiment;

FIG. 16 is a flow chart exemplifying a second file transmission process of a Wi-Gig access point according to the second embodiment;

FIG. 17 is a block diagram depicting an example of a hardware configuration of a portable terminal;

FIG. 18 is a block diagram depicting an example of a hardware configuration of a relay apparatus; and

FIG. 19 is a block diagram exemplifying a hardware configuration of a management apparatus.

### DESCRIPTION OF EMBODIMENTS

Wi-Gig data has high power consumption for transfer of data. For example, if a communication apparatus incorporating a Wi-Gig communication function places its Wi-Gig communication function into an on state to perform a detection operation of a radio wave from a Wi-Gig access point in order to detect a communication area (Wi-Gig communication area) in which wireless coupling to the Wi-Gig access point is possible, even if the communication apparatus is outside the Wi-Gig communication area, the communication apparatus consumes power. Then, if the communication apparatus performs detection of a communication area using a communication function of a wireless communication standard that has comparatively high power consumption like Wi-Gig, much power is consumed.

As one aspect of the present embodiments, provided are solutions for being able to reduce the power consumption of a communication apparatus for detection of a communication area of wireless communication.

In the following, several embodiments of the present technology are described in detail with reference to the drawings. It is to be noted that, in a plurality of drawings, corresponding elements are denoted by the same reference characters.

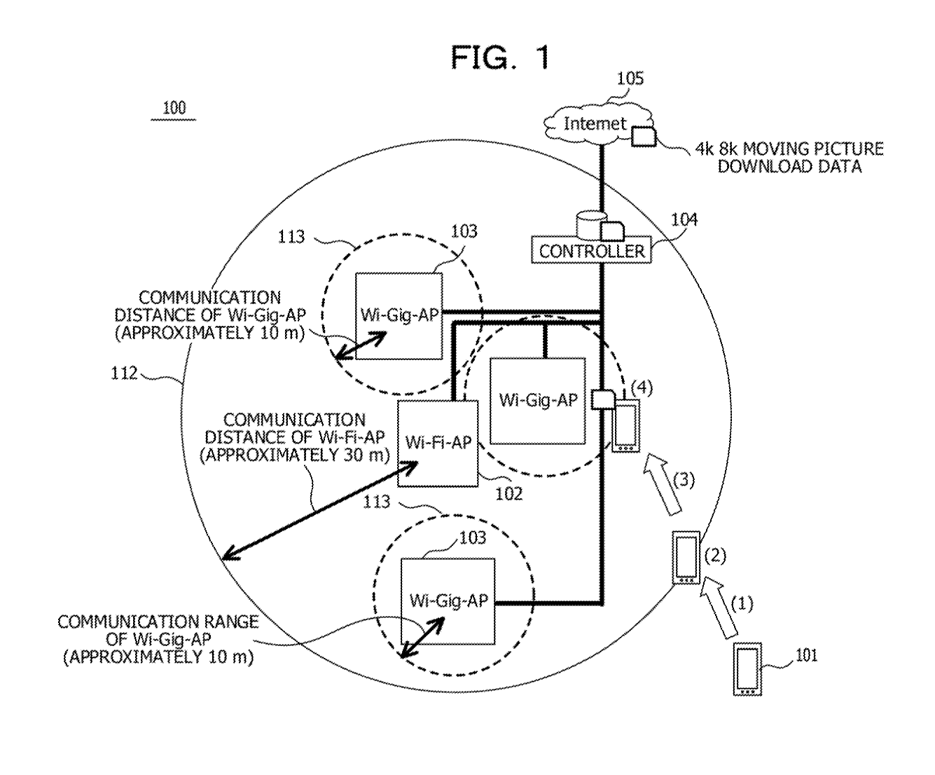

FIG. 1 is a view depicting an example of an exemplary communication system. A communication system 100 depicted in FIG. 1 includes, for example, a Wi-Fi access point (AP) 102, a Wi-Gig access point 103, and a controller 104. The communication distance of the Wi-Fi access point 102 is, for example, approximately 30 m in the maximum, and in FIG. 1, the range of the communication distance of the Wi-Fi access point 102 is indicated by a Wi-Fi communication area 112. Meanwhile, the communication distance of the Wi-Gig access point 103 is approximately 10 m in the maximum, for example, using beam forming, and in FIG. 1, the range of the communication distance of the Wi-Gig access point 103 is indicated by a Wi-Gig communication area 113. The communication distance of Wi-Gig is shorter than communication distance of Wi-Fi, and in the example of FIG. 1, a plurality of Wi-Gig communication areas 113 of the Wi-Gig access points 103 are disposed in the Wi-Fi communication area 112 of the Wi-Fi access point 102. The controller 104 manages, for example, the Wi-Fi access point 102 and the Wi-Gig access points 103 positioned in the Wi-Fi communication area 112 and mediates communication between these access points and the Internet 105. Meanwhile, a portable terminal 101 may be a communication apparatus that may be coupled to the Wi-Fi access point 102 and a Wi-Gig access point 103. It is to be noted that the portable terminal 101 is a communication apparatus such as a portable telephone set, a smartphone, or a laptop computer. The Wi-Fi access point 102 may operate as a first relay apparatus. The Wi-Gig access point 103 may operate as a second relay apparatus.

Here, it is assumed that a user who owns the portable terminal 101 tries to couple the portable terminal 101 to the Wi-Gig access point 103 to transfer a great amount of data of a movie file or the like. In this case, as the user moves, the portable terminal 101 approaches the Wi-Fi communication area 112 of the Wi-Fi access point 102 ((1) of FIG. 1). If the portable terminal 101 enters the Wi-Fi communication area 112, the portable terminal 101 establishes coupling to the Wi-Fi access point 102, and the Wi-Fi access point 102 notifies the portable terminal 101 that the portable terminal 101 is in an area in which the Wi-Fi access point 102 provides communication by Wi-Gig ((2) of FIG. 1). When the portable terminal 101 receives the notification, the portable terminal 101 turns on, for example, a Wi-Gig communication unit 214 or a module of Wi-Gig to establish a reception state in which a radio wave of Wi-Gig may be received thereby to start capture of a radio wave from the Wi-Gig access point 103 ((3) of FIG. 1). Then, after the portable terminal 101 enters, for example, the Wi-Gig communication area 113 of a Wi-Gig access point 103, the portable terminal 101 starts communication by Wi-Gig ((4) of FIG. 1). Consequently, the user may download or upload a large amount of data, for example, of a movie file at a high speed from or to the portable terminal 101 using communication of Wi-Gig.

However, wireless communication of Wi-Gig has high power consumption for transfer of a wireless signal in comparison with power consumption of the other wireless standards. For example, the power consumption for reception of Wi-Gig communication is approximately 960 mW, and the power consumption for transmission of Wi-Gig communication is approximately 1190 mW. Meanwhile, the power consumption for reception of Wi-Fi communication is, for example, approximately 400 mW. In this manner, there is a tendency that the power consumption for transmission and reception of Wi-Gig is higher than, for example, that of Wi-Fi. In the example of FIG. 1, also when the portable terminal 101 is outside the Wi-Gig communication area 113 of the Wi-Gig access point 103 in the case of (3), the portable terminal 101 remains in a reception state of Wi-Gig. Therefore, even when the portable terminal 101 is not in a communicating state using Wi-Gig, the portable terminal 101 consumes power using a communication apparatus of Wi-Gig for the detection of the Wi-Gig communication area 113. If detection of a communication area is performed using a communication apparatus of a wireless communication standard having high power consumption for communication in this manner, for example, much power is consumed.

Therefore, it is demanded to provide a technology for reducing the power consumption of a portable terminal for detection of a communication area of wireless communication. For example, it is preferable that detection of the Wi-Gig communication area 113 may be executed with reduced power consumption.

In the embodiments described below, the Wi-Fi access point 102 transmits a radio wave by beam forming (sometimes referred to also as sector) to the portable terminal 101. To this end, the Wi-Fi access point 102 may detect a direction in which the portable terminal 101 exists. Here, the Wi-Fi access point 102 is an example of a first relay apparatus, and Wi-Fi is an example of a first wireless communication method.

The Wi-Fi access point 102 transmits, when the portable terminal 101 enters in a direction (sometimes referred to also as sector) in which a Wi-Gig access point 103 exists, to the portable terminal 101 an entering notification having setting information representative of an intensity range of a radio wave. The intensity range indicated by the setting information is configured by, for example, an intensity range in which the portable terminal 101 under a certain situation is to receive the radio wave from the first relay apparatus. Here, the Wi-Gig access point 103 is an example of a second relay apparatus, and Wi-Gig is an example of a second wireless communication method. The entering notification may include information of an identification identifier (ID), an upper limit threshold value, and a lower limit threshold value of an entry corresponding to the Wi-Gig access point 103 existing in a direction in which a radio wave is transmitted by beam forming from among entries of radio wave intensity management information 500 hereinafter described, for example. The information of an upper limit threshold value and a lower limit threshold value is an example of setting information indicative of an intensity range of a radio wave. Further, the value of an intensity range indicated by the setting information may be a range between the upper limit threshold value and the ower limit threshold value.

The portable terminal 101 may detect from an entering notification from the Wi-Fi access point 102 that the portable terminal 101 enters a direction (e.g., a sector) in which a Wi-Gig access point 103 exists. In this case, the portable terminal 101 measures the reception radio wave intensity (also called received signal strength indication) of a radio wave from the Wi-Fi access point 102 and decides whether or not the reception radio wave intensity obtained by the measurement indicates a value within the intensity range indicated by the setting information included in the entering information described above. Here, the reception radio wave intensity of a radio wave from the Wi-Fi access point 102 has a correlation with the distance from the Wi-Fi access point 102 to the portable terminal 101. Therefore, for example the distance from the Wi-Fi access point 102 to the Wi-Gig communication area 113 may be represented by an intensity of the reception radio wave from the Wi-Fi access point 102, and an intensity range of the reception radio wave corresponding to the Wi-Gig communication area 113 may be set. Consequently, the portable terminal 101 may detect based on the intensity of the reception radio wave from the Wi-Fi access point 102 that the portable terminal 101 enters the Wi-Gig communication area 113 of the Wi-Gig access point 103. In the portable terminal 101, the power consumption for the Wi-Fi communication function is lower than the power consumption for the Wi-Gig communication function. Therefore, by executing detection of the Wi-Gig communication area 113 using a radio wave of Wi-Fi, reduction of the power consumption of the portable terminal 101 may be achieved. In the following, embodiments are described.

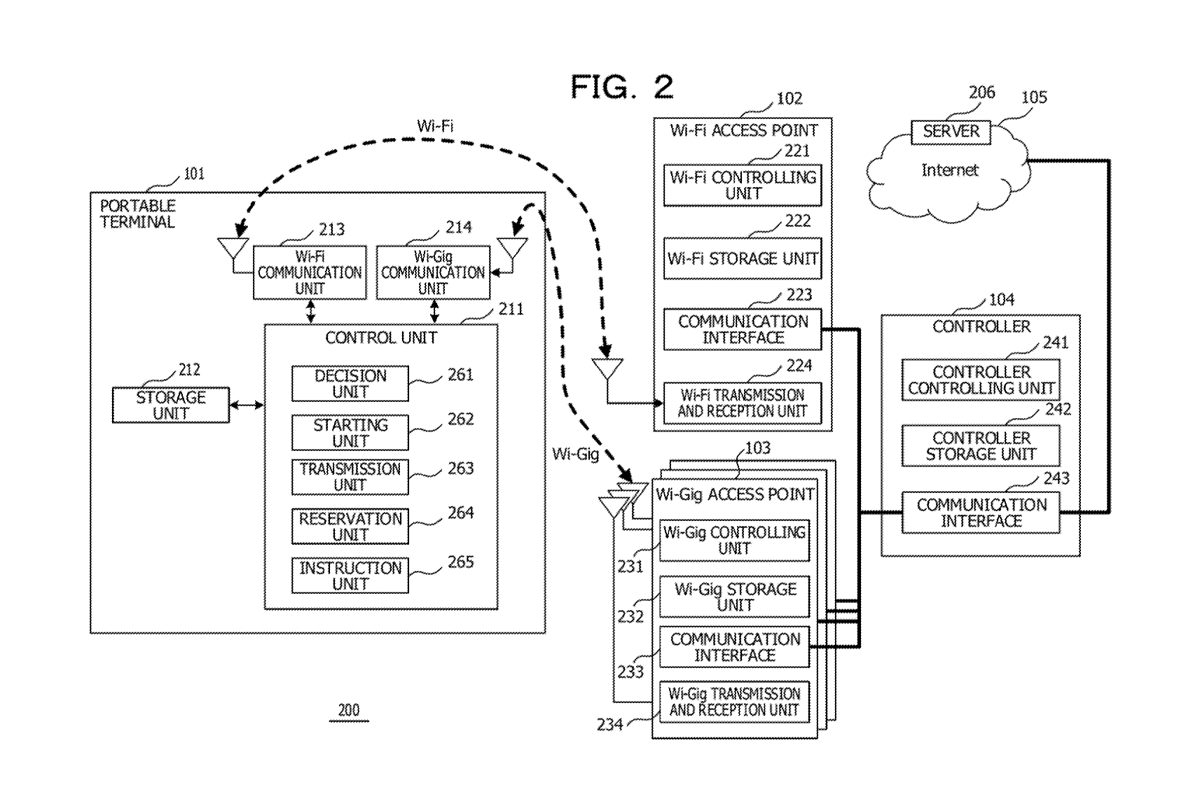

FIG. 2 is a block diagram exemplifying a configuration of a communication system according to embodiments. A communication system 200 depicted in FIG. 2 includes, for example, a portable terminal 101, a Wi-Fi access point 102, a Wi-Gig access point 103, and a controller 104. The Wi-Fi access point 102 and the Wi-Gig access point 103 transfer data to and from the controller 104. The portable terminal 101 couples to the Wi-Fi access point 102 or the Wi-Gig access point 103 and couples to the Internet 105 through the controller 104. It is to be noted that, for example, a plurality of Wi-Gig access points 103 may be included in a Wi-Fi communication area 112 of the Wi-Fi access point 102.

The portable terminal 101 includes, for example, a control unit 211, a storage unit 212, a Wi-Fi communication unit 213, and a Wi-Gig communication unit 214. The control unit 211 controls each component of the portable terminal 101. The control unit 211 includes, for example, a decision unit 261, a starting unit 262, a transmission unit 263, a reservation unit 264, and an instruction unit 265. The storage unit 212 has stored therein programs and information such as information of a decision range of a radio wave intensity hereinafter described and a Wi-Gig direction entering flag. The Wi-Fi communication unit 213 couples to the Wi-Fi access point 102 in accordance with an instruction of the control unit 211. Meanwhile, the Wi-Gig communication unit 214 couples to the Wi-Gig access point 103 in accordance with an instruction of the control unit 211. Further details of each component of the portable terminal 101 and details of the information stored in the storage unit 212 are hereinafter described. The portable terminal 101 is an example of a communication apparatus.

The Wi-Fi access point 102 is a relay apparatus that relays communication between the portable terminal 101 and the controller 104. The Wi-Fi access point 102 includes, for example, a Wi-Fi controlling unit 221, a Wi-Fi storage unit 222, a communication interface 223, and a Wi-Fi transmission and reception unit 224. The Wi-Fi controlling unit 221 controls each component of the Wi-Fi access point 102. Further, the communication interface 223 communicates with a communication interface 243 of the controller 104 in accordance with an instruction of the Wi-Fi controlling unit 221. The Wi-Fi transmission and reception unit 224 couples to the Wi-Fi communication unit 213 of the portable terminal 101 in accordance with an instruction of the Wi-Fi controlling unit 221. The Wi-Fi controlling unit 221 may calculate, when the Wi-Fi transmission and reception unit 224 couples to the Wi-Fi communication unit 213 of the portable terminal 101, a direction in which the portable terminal 101 exists, for example, using beam forming. The Wi-Fi access point 102 is an example of a first relay apparatus, and Wi-Fi is an example of a first wireless communication method.

The Wi-Gig access point 103 is a relay apparatus that relays communication between the portable terminal 101 and the controller 104. The Wi-Gig access point 103 includes, for example, a Wi-Gig controlling unit 231, a Wi-Gig storage unit 232, a communication interface 233, and a Wi-Gig transmission and reception unit 234. The Wi-Gig controlling unit 231 controls each component of the Wi-Gig access point 103. Further, the communication interface 233 communicates with the communication interface 243 of the controller 104 in accordance with an instruction of the Wi-Gig controlling unit 231. The Wi-Gig transmission and reception unit 234 couples to the Wi-Gig communication unit 214 of the portable terminal 101 in accordance with an instruction of the Wi-Gig controlling unit 231. The Wi-Gig access point 103 is an example of a second relay apparatus, and Wi-Gig is an example of a second wireless communication method.

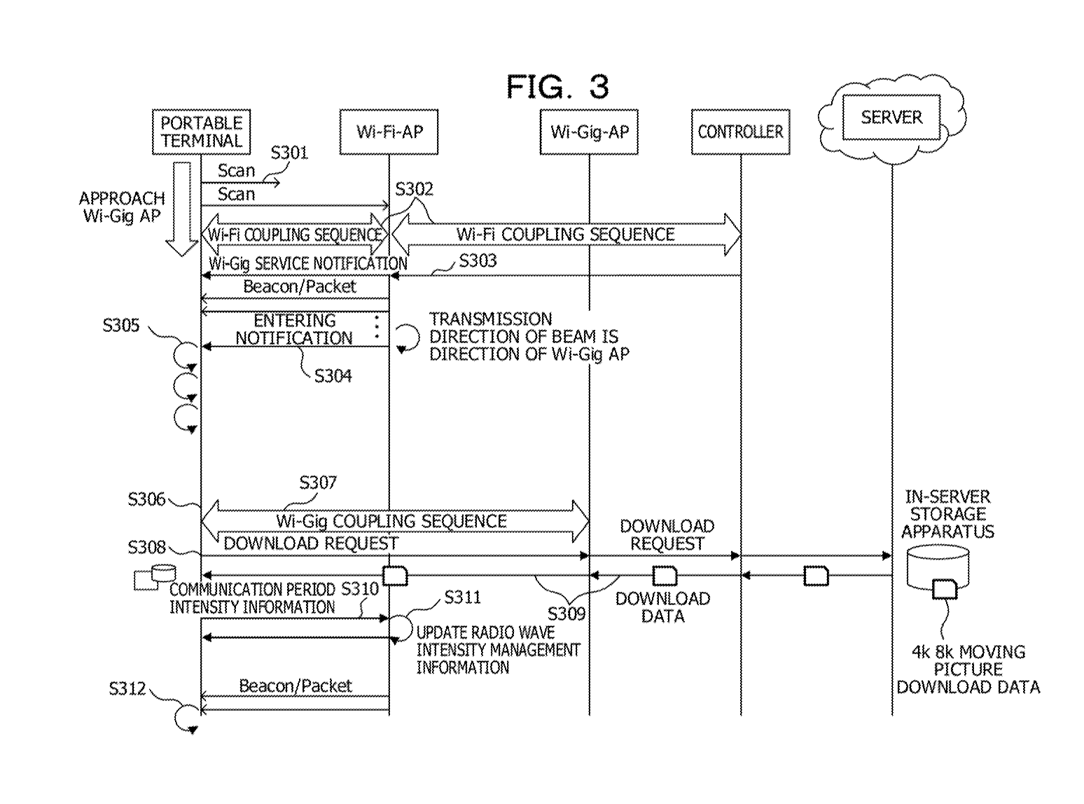

The controller 104 is a management apparatus that manages, for example, the Wi-Fi access point 102 and the Wi-Gig access point 103. The controller 104 includes, for example, a controller controlling unit 241, a controller storage unit 242, and the communication interface 243. The controller controlling unit 241 controls each component of the controller 104. The communication interface 243 operates, for example, in accordance with an instruction of the controller controlling unit 241 and mediates communication of the Wi-Fi access point 102 and the Wi-Gig access point 103 with the Internet 105.

<First Embodiment> FIG. 3 is a sequence diagram exemplifying a sequence of a communication coupling process according to a first embodiment. At step 301 (in the following description, step is denoted as “S,” and such a notation as S301 is used), the portable terminal 101 scans radio waves of Then, if the portable terminal 101 receives a radio wave from a Wi-Fi access point 102, the portable terminal 101 executes a Wi-Fi coupling sequence to establish communication coupling to the Wi-Fi access point 102 at S302. Then, the portable terminal 101 couples to the controller 104 through the Wi-Fi access point 102.

At S303, the controller 104 issues a Wi-Gig service provision notification indicating that an area in which a communication service of Wi-Gig is provided exists to the portable terminal 101 through the Wi-Fi access point 102. Thereafter, the Wi-Fi access point 102 transmits a radio wave to the portable terminal 101 using beam forming and decides, while the Wi-Fi access point 102 executes communication with the portable terminal 101, whether or not the transmission direction of the beam is a given direction in which the Wi-Gig access point 103 exists. At S304, if the transmission direction of the beam is the given direction in which the Wi-Gig access point 103 exists, the Wi-Fi access point 102 transmits an entering notification to the portable terminal 101. The entering notification may include an identification ID of the Wi-Gig access point 103 existing in the transmission direction of the beam and setting information indicative of a decision range of the reception radio wave intensity. The entering notification notifies that, for example, the portable terminal 101 enters in the direction in which the Wi-Gig access point 103 exists. The decision range of the radio wave intensity may be information indicative of an intensity range of a reception radio wave of Wi-Fi from the Wi-Fi access point 102 detected within the Wi-Gig communication area 113 of the Wi-Gig access point 103 existing in the beam direction.

At S305, when the portable terminal 101 receives the entering notification, the portable terminal 101 measures the reception radio wave intensity of Wi-Fi and decides whether or not the reception radio wave intensity indicates a value within the decision range of the reception radio wave intensity indicated by the setting information included in the entering notification. Then, if the measured reception radio wave intensity of Wi-Fi is not within the decision range, the portable terminal 101 repeats the process at S305. If the measured reception radio wave intensity of Wi-Fi is within the decision range, the portable terminal 101 changes over the Wi-Gig communication unit 214 or the module of Wi-Gig, for example, from an off state to an on state to start detection of a radio wave from the Wi-Gig access point 103 at S306. It is to be noted that, when the measured reception radio wave intensity of Wi-Fi is within the decision range, the possibility that the portable terminal 101 may be in the Wi-Gig communication area 113 of the Wi-Gig access point 103 is high. If the portable terminal 101 actually is in the Wi-Gig communication area 113 (for example, if the intensity of a reception radio wave from the Wi-Gig access point 103 is equal to or higher than a given value), at S307, the portable terminal 101 executes a Wi-Gig coupling sequence to establish coupling to the Wi-Gig access point 103. It is to be noted that, also after the portable terminal 101 establishes coupling to the Wi-Gig access point 103, the portable terminal 101 may always or intermittently execute measurement of a reception radio wave from the Wi-Fi access point 102. The measurement of a reception radio wave from the Wi-Fi access point 102 after coupling to the Wi-Gig access point 103 is established may be executed by the Wi-Fi communication unit 213 or may be executed by the Wi-Gig communication unit 214. Where a function for executing measurement of a reception radio wave from the Wi-Fi access point 102 is incorporated in the Wi-Gig communication unit 214, within a period within which coupling to the Wi-Gig access point 103 is kept established, the portable terminal 101 may change over the Wi-Fi communication unit 213 to an off state to suppress power consumption.

At S308, the portable terminal 101 accesses the Internet 105 from the controller 104 through the Wi-Gig access point 103 using Wi-Gig communication, for example, to request downloading of data to a server 206. At S309, the controller 104 transmits data downloaded from the server 206 to the portable terminal 101 through the Wi-Gig access point 103 by Wi-Gig communication. At S310, for example, when reception of data is completed, the portable terminal 101 transmits communication period intensity information relating to a Wi-Fi radio wave intensity during a period within which the portable terminal 101 continues to couple to the Wi-Gig access point 103 to the Wi-Fi access point 102. It is to be noted that the communication period intensity information may include a maximum value and a minimum value of the radio wave intensity of the Wi-Fi access point 102 detected within the period within which the portable terminal 101 couples to the Wi-Gig access point 103 and the identification ID of the coupled Wi-Gig access point 103.

At S311, the Wi-Fi access point 102 updates the decision range of the radio wave intensity to be used for decision using the received communication period intensity information. At S312 if the portable terminal 101 goes out of the Wi-Gig communication area 113, the portable terminal 101 turns off the Wi-Gig communication unit 214 or the module of Wi-Gig to establish a reception stopping state in which it stops reception of Wi-Gig radio waves. After the reception stopping state for stopping reception of Wi-Gig radio waves is established, the present sequence is ended.

As described above, the portable terminal 101 decides, based on an entering notification based on a transmission direction of a radio wave from the Wi-Fi access point 102 and a decision range of a radio wave intensity of Wi-Fi included in the entering notification, whether or not the portable terminal 101 enters the Wi-Gig communication area 113. It is to be noted that the direction of beam forming of Wi-Fi and the decision range of the radio wave intensity have the following relationship with the Wi-Gig communication area 113.

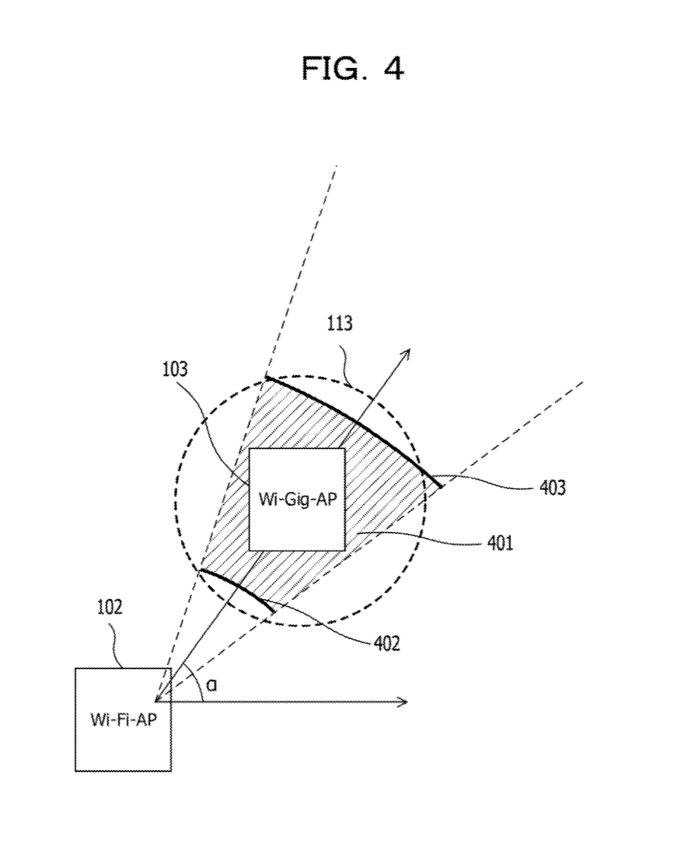

FIG. 4 is a view exemplifying a relationship between a radio wave of a Wi-Fi access point transmitted using beam forming according to the embodiments and a Wi-Gig communication area of a Wi-Gig access point. The

Wi-Fi access point illustrated in FIG. 4 may be the Wi-Fi access point 102 illustrated in FIG. 2. In FIG. 4, the Wi-Fi access point 102 performs beam forming at an angle α to transmit a radio wave, and the radio wave is sent with a certain width toward a direction of the angle α. Further, in FIG. 4, a Wi-Gig access point 103 and a Wi-Gig communication area 113 are depicted. A slanting line region 401 is a region formed based on a spread of a radio wave based on the angle α of the beam forming of the Wi-Fi access point 102 and the radio wave intensity of a radio wave from the Wi-Fi access point 102. The radio wave intensity of a radio wave from the Wi-Fi access point 102 corresponds to the distance from the Wi-Fi access point 102. Therefore, setting of a decision range of the radio wave intensity corresponding to the Wi-Gig communication area 113 described above may be executed, for example, in the following manner. For example, the radio wave intensity of Wi-Fi corresponding to the distance from the Wi-Fi access point 102 to an arc 402 on the inner side of the slanting line region 401 may be set to an upper limit threshold value for, the decision range. Further, for example, the radio wave intensity of Wi-Fi corresponding to the distance from the Wi-Fi access point 102 to an arc 403 on the outer side of the slanting line region 401 may be set to a lower limit threshold value for the decision range. Accordingly, with the present embodiment, the Wi-Gig communication area 113 may be associated with the slanting line region 401 defined using the angle of the beam forming from the Wi-Fi access point 102 and the decision range of the radio wave intensity of Wi-Fi. It is to be noted that the Wi-Gig communication area 113 and the slanting line region 401 may not fully coincide with each other and may be utilized if they overlap with each other to some degree. Further, with the present embodiment, it is possible to detect that the Wi-Gig communication area 113 is entered using the angle of the beam forming from the Wi-Fi access point 102 and the radio wave intensity. Therefore, it may be suppressed, for example, to turn on, in order to detect a radio wave of Wi-Gig, the Wi-Gig communication unit 214 or the module of Wi-Gig whose power consumption is high although the Wi-Gig communication area 113 is not entered. In the following, details of a process corresponding to the sequence according to the embodiment described above are exemplified.

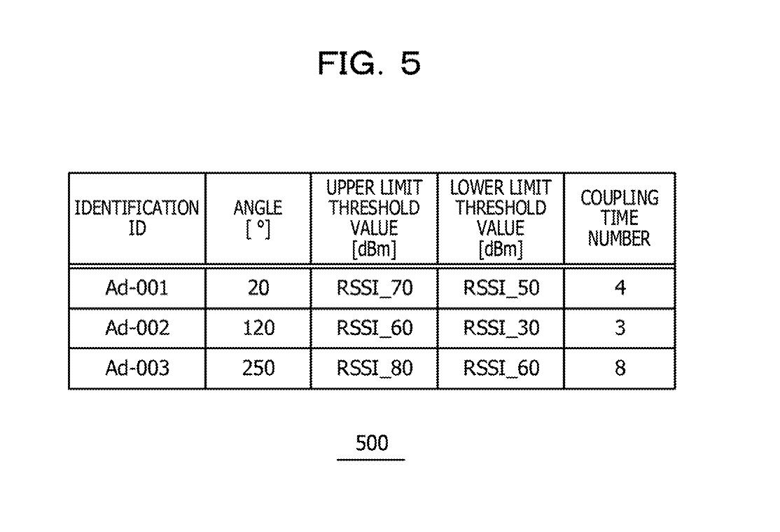

FIG. 5 is a view exemplifying radio wave intensity management information stored in a Wi-Fi storage unit of a Wi-Fi access point according to the embodiment. The Wi-Fi storage unit of the Wi-Fi access point illustrated in FIG. 5 may be the Wi-Fi storage unit 222 of the Wi-Fi access point 102 illustrated in FIG. 2. In a radio wave intensity management information 500 depicted in FIG. 5, entries including, for example, an identification ID, an angle, an upper limit threshold value, a lower limit threshold value, and a number of times of coupling (coupling time number) are registered. The identification ID is an ID for identifying, for example, the Wi-Gig access point 103. The angle is an angle indicative of a beam direction in which, for example, a Wi-Gig access point 103 identified with the identification ID of the entry exists. The upper limit threshold value and the lower limit threshold value represent a decision range of the radio wave intensity of Wi-Fi, for example corresponding to the Wi-Gig communication area 113 of the Wi-Gig access point 103 identified with the identification ID the entry. The coupling time number may be a number of times by which some portable terminal including the portable terminal 101 was coupled to the Wi-Gig access point 103 in the past.

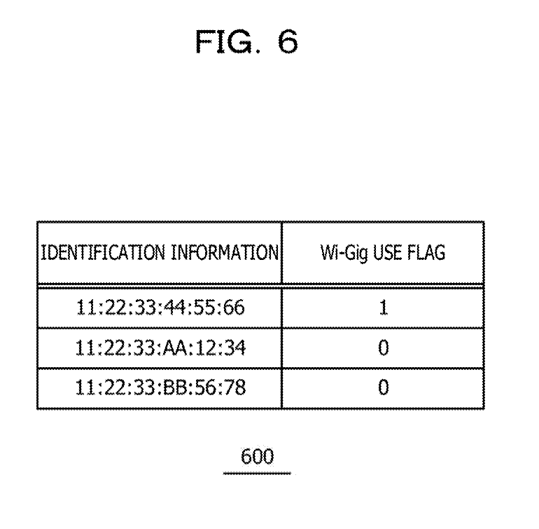

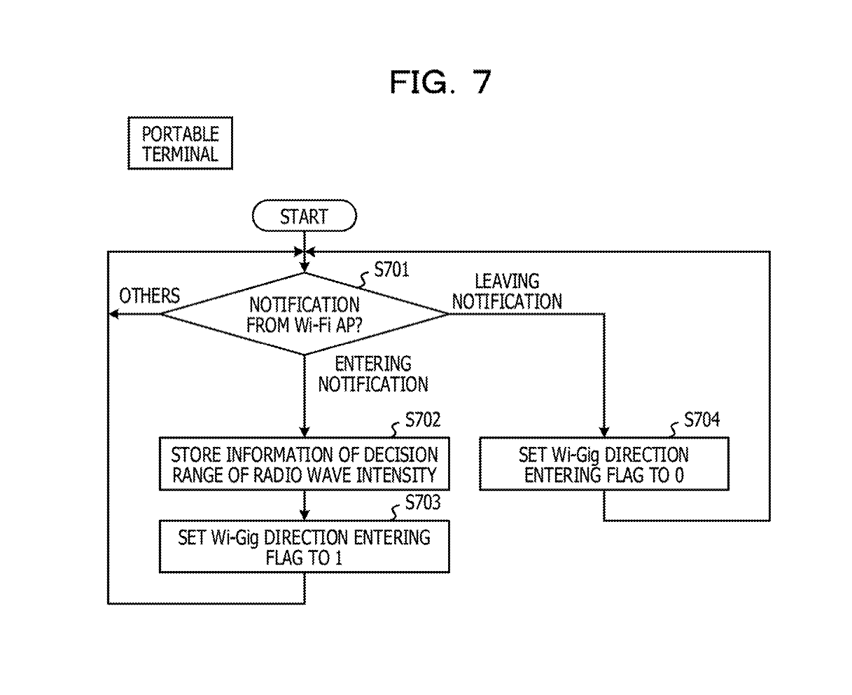

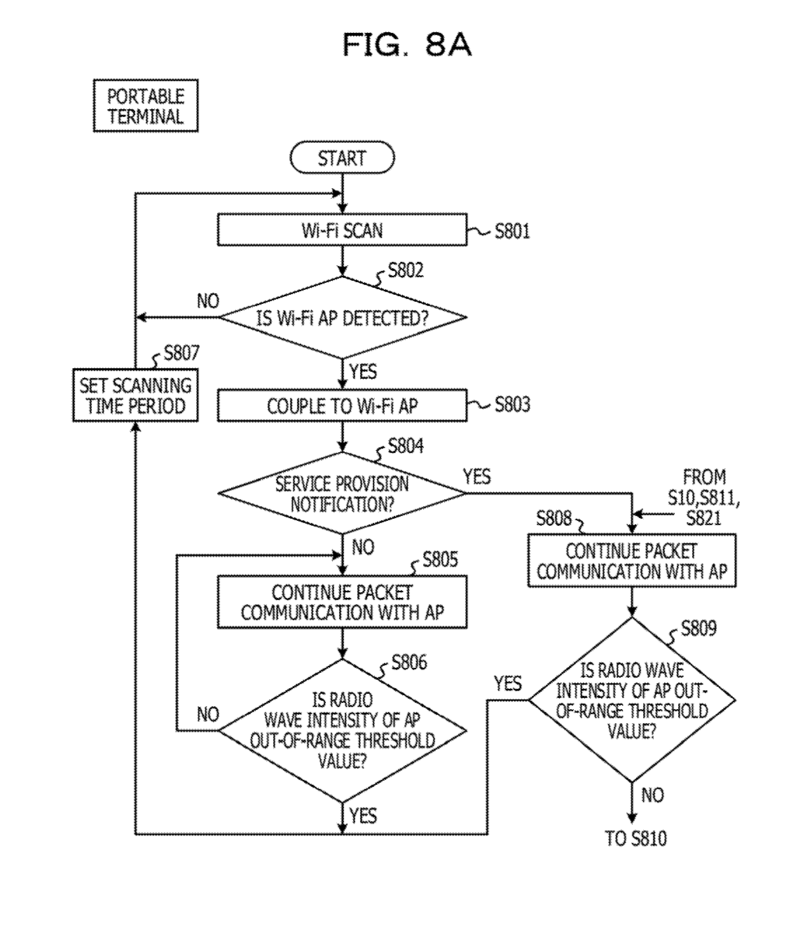

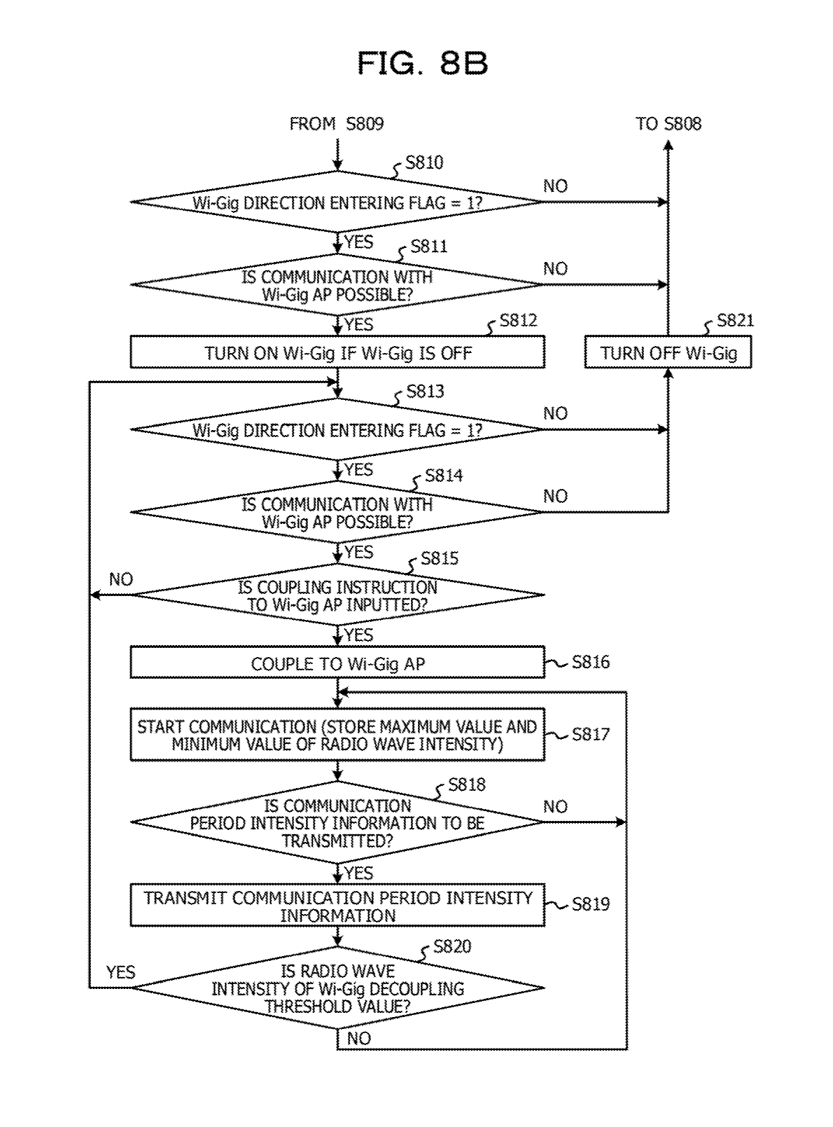

FIG. 6 is a view exemplifying portable terminal information stored in a Wi-Fi storage unit of a Wi-Fi access point according to the embodiment, The Wi-Fi storage unit of the Wi-Fi access point illustrated in FIG. 6 may be the Wi-Fi storage unit 222 of the Wi-Fi access, point 102 illustrated in FIG. 2. In portable terminal information 600 depicted in FIG. 6, an entry, for example, of the portable terminal 101 coupled to the Wi-Fi access point 102 is registered. Each entry includes identification information for identifying the portable terminal 101 coupled to the Wi-Fi access point 102 and a Wi-Gig use flag for setting whether or not a portable terminal enters in a direction in which the installation position of the Wi-Gig access point 103 exists. A communication coupling process according to the embodiment in which the information mentioned above is used is described.

<Process of Portable Terminal> FIG. 7 is a flow chart exemplifying a Wi-Gig direction entering flag setting process executed by a portable terminal according to the first embodiment. The portable terminal illustrated by reference to FIG. 7 may be the portable terminal 101 depicted in FIG. 2. The control unit 211 of the portable terminal 101 may, for example, start the Wi-Gig direction entering flag setting process of FIG. 7 when the portable terminal 101 receives a Wi-Fi service provision notification from the Wi-Fi access point 102 to which coupling is established in an operation flow of FIG. 8 hereinafter described. It is to be noted that the Wi-Gig service provision notification is a notification indicating an area that a service, for example, by Wi-Gig is provided.

At S701, the control unit 211 of the portable terminal 101 decides whether or not the control unit 211 receives an entering notification or a leaving notification from the Wi-Fi access point 102 coupled to the portable terminal 101. When none of an entering notification and a leaving notification is received, the processing repeats the process at S701. On the other hand, if an entering notification is received, the processing advances to S702. It is to be noted that it is assumed as described below that the direction of beam forming in which the Wi-Fi access point 102 transmits a radio wave, for example, to the portable terminal 101 overlaps with the direction in which one of the Wi-Gig access points 103 existing in the Wi-Fi communication area 112 exists. In this case, the Wi-Fi access point 102 places information, of an entry regarding the Wi-Gig access point 103 existing in the beam direction from within the radio wave intensity management information 500 into an entering notification and transmits the entering notification to the portable terminal 101. For example, the entering notification is a notification indicating that, the portable terminal 101 enters in the transmission direction of the beam in which a certain Wi-Gig access point 103 exists. The entering notification may include an identification ID of the Wi-Gig access point 103 existing in the transmission direction of the beam and information of the decision range for a radio wave intensity corresponding to the Wi-Gig communication area 113.

At S702, the control unit 211 reads out the information of the decision range of the radio wave intensity from the received entering notification and stores the information into the storage unit 212. At S703, the control unit 211 sets the value of the Wi-Gig direction entering flag indicative of whether or not the portable terminal 101 enters in the direction in which the installation position of the Wi-Gig access point 103 exists, for example, to 1 that indicates that the portable terminal 101 enters in the direction. Then, the processing returns to S701.

On the other hand, in the case where a leaving notification is received at S701, the processing advances to S704. At S704, the control unit 211 sets the Wi-Gig direction entering flag, for example, to 0 that indicates that the portable terminal 101 is displaced from the direction in which the installation position of the Wi-Gig access point 103 exists. Thereafter, the processing returns to S701.

As described above, in accordance with the operation flow of FIG. 7, the control unit 211 of the portable terminal 101 sets the value of the Wi-Gig direction entering flag of the storage unit 212 based on a notification from the Wi-Fi access point 102. The value set to the Wi-Gig direction entering flag may be used to decide whether or not the portable terminal 101 enters a transmission direction of the beam in which the Wi-Gig access point 103 exists in an operation flow of FIG. 8 hereinafter described.

FIG. 8 is a flow chart exemplifying a communication coupling process according to the first embodiment. The control unit 211 may start the communication coupling process of FIG. 8, for example, when the portable terminal 101 is activated.

At S801, the control unit 211 of the portable terminal 101 scans radio waves of Wi-Fi to search for a Wi-Fi access point 102. At S802, the control unit 211 decides whether or not a Wi-Fi access point 102 is detected successfully. If the Wi-Fi access point 102 is not detected successfully (NO at S802), the processing advances to S807, at which the control unit 211 sets a scanning time period. For example, the control unit 211 may set different scanning time periods like 10 seconds, 20 seconds, 60 seconds, and 180 seconds and execute scanning using turning on of a display screen image of the portable terminal 101 or the like as a trigger. The period of scanning of the Wi-Fi access point 102 may be, for example, fixed or variable.

On the other hand, if the Wi-Fi access point 102 is detected at S802 (YES at S802), the processing advances to S803, at which the control unit 211 controls the Wi-Fi communication unit 213 to establish coupling to the Wi-Fi access point 102. For example, the control unit 211 may complete authentication through the Wi-Fi access point 102 by the controller 104 at S803 and establish coupling.

At S804, the control unit 211 decides whether or not a Wi-Gig service provision notification indicating that a service by Wi-Gig is provided is received from the Wi-Fi access point 102. It is to be noted that the Wi-Fi access point 102 may include a Wi-Gig access point 103 in the Wi-Fi communication area 112, for example, as exemplified in FIG. 1. In this case, if the Wi-Fi access point 102 establishes coupling to the portable terminal 101, the Wi-Fi access point 102 may transmit a Wi-Gig service provision notification indicating that the portable terminal 101 exists in an area in which the Wi-Fi access point 102 provides a communication service by Wi-Gig to the portable terminal 101. If a Wi-Gig service provision notification is not received by the portable terminal 101 at S804 (NO at S804), the processing advances to S805.

At S805, the control unit 211 continues packet communication with;, the Wi-Fi access point 102. At S806, the control unit 211 decides whether or not the radio wave intensity of a radio wave from the Wi-Fi access point 102 is equal to or lower than a threshold value, which indicates the out-of-range. If the radio wave intensity of a radio wave from the Wi-Fi access point 102 is equal to or lower than the threshold value, which indicates the out-of-range (YES at S806), the processing advances to S807. On the other hand, if the radio wave intensity of a radio wave from the Wi-Fi access point 102 is not equal to or lower than the threshold value, which indicates the out-of-range (NO at S806), the processing returns to S805 to repeat the processes.

On the other hand, if a Wi-Gig service provision notification is received at S804 (YES at S804), the processing advances to S808. At S808, the control unit 211 continues packet communication with the Wi-Fi access point 102. At S809, the control unit 211 decides whether or not the radio wave intensity of a radio wave from the Wi-Fi access point 102 is equal to or lower than a threshold value, which indicates the out-of-range. If the radio wave intensity of a radio wave from the Wi-Fi access point 102 is equal to or lower than a threshold value, which indicates the out-of-range (YES at S809), the processing advances to S807. On the other hand, if the radio wave intensity of a radio wave from the Wi-Fi access point 102 is not equal to or lower than a threshold value, which indicates the out-of-range (NO at S809), the processing advances to S810.

At S810, the control unit 211 refers to the value of the Wi-Gig direction entering flag of the storage unit 212 to decide whether or not the value of the Wi-Gig direction entering flag is 1 that indicates that the portable terminal 101 enters in the transmission direction of the beam in which the Wi-Gig access point 103 exists. If the value of the Wi-Gig direction entering flag is not 1 that, indicates that the portable terminal 101 enters in the transmission direction of the beam in which the Wi-Gig access point 103 exists (NO at S810), the processing returns to S808. On the other hand, if the value of the Wi-Gig direction entering flag is 1 that indicates that the portable terminal 101 enters in the transmission direction of the beam in which the Wi-Gig access point 103 exists (YES at S810), the processing advances to S811.

At S811, the control unit 211 decides, based on the radio wave intensity of a radio wave from the Wi-Fi access point 102 and the decision range for the radio wave intensity having been stored in the storage unit 212, whether or not it is possible to communicate with the Wi-Gig access point 103. For example, the control unit 211 decides whether or not the radio wave intensity of a radio wave from the coupled Wi-Fi access point 102 is within the decision range for the radio wave intensity having been stored into the storage unit 212 at S702 of FIG. 7. If the radio wave intensity of a radio wave from the Wi-Fi access point 102 received by the portable terminal 101 is outside the decision range for the radio wave intensity having been stored in the storage unit 212, the control unit 211 may make a decision of NO at S811, and the processing returns to S808. This is because, when the radio wave intensity of Wi-Fi received by the portable terminal 101 is outside the decision range for the radio wave intensity having been stored in the storage unit 212, it is estimated that the portable terminal 101 is outside the Wi-Gig communication area 113.

On the other hand, if the radio wave intensity of a radio wave from the Wi-Fi access point 102 is within the decision range for the radio wave intensity having been stored in the storage unit 212, it is estimated that the portable terminal 101 is within the Wi-Gig communication area 113. In this case, the control unit 211 may decide that it is possible to communicate with the Wi-Gig access point 103, and the control unit 211 makes a decision of YES at S811. Thus, the processing advances to S812.

At S812, the control unit 211 turns on, for example, the Wi-Gig communication unit 214 or the module of Wi-Gig to establish a reception state in which a radio wave of Wi-Gig may be received. At S813, the control unit 211 refers to the value of the Wi-Gig direction entering flag of the storage unit 212 to decide whether or not the value of the Wi-Gig direction entering flag is 1. If the value of the Wi-Gig direction entering flag is not 1 (NO at S813), this indicates that the portable terminal 101 is displaced from the transmission direction of the beam in which the Wi-Gig access point 103 exists, and the processing advances to S821. At S821, the control unit 211 turns off the Wi-Gig communication unit 214 or the module of Wi-Gig to cancel the reception state in which a radio wave of Wi-Gig may be received. Consequently, the power to be provided to the Wi-Gig communication unit 214 is reduced.

On the other hand, if the value of the Wi-Gig direction entering flag is 1 that indicates that the portable terminal 101 enters in the transmission direction of the beam in which the Wi-Gig access point 103 exists (YES at S813), the processing advances to S814.

At S814, the control unit 211 decides based on the radio wave intensity of a radio wave from the Wi-Fi access point 102 and the decision range of the radio wave intensity having been stored in the storage unit 212, whether or not it is possible to communicate with the Wi-Gig access point 103. For example, the control unit 211 decides whether or not the radio wave intensity of a Wi-Fi radio wave is within the decision range of the radio wave intensity having been stored into the storage unit 212 at S702 of FIG. 7. If the radio wave intensity of Wi-Fi is outside the decision range of the radio wave intensity having been stored into the storage unit 212, the control unit 211 may make a decision of NO at S814, and the processing advances to S821. On the other hand, if the radio wave intensity of Wi-Fi is within the decision range of the radio wave intensity having been stored in the storage unit 212, the control unit 211 may make a decision of YES at S814, and the processing advances to S815.

At S815, the control unit 211 decides whether or not an instruction to couple to the Wi-Gig access point 103 is inputted from a user. If an instruction to couple to the Wi-Gig access point 103 is not inputted (NO at S815), the processing returns to S813. On the other hand, if an instruction to couple to the Wi-Gig access point 103 is inputted (YES at S815), the processing advances to S816. At S815, the control unit 211 controls the Wi-Gig communication unit 214 to execute a coupling sequence for coupling to the Wi-Gig access point 103 thereby to couple to the Wi-Gig access point 103. It is to be noted that, if the coupling to the Wi-Gig access point 103 is completed, the control unit 211 may display on a display screen image of a display apparatus provided in the portable terminal 101, information such as an icon indicative of the coupling to the Wi-Gig access point 103. The process at S815 may be omitted. In this case, if the control unit 211 decides at S814 that it is possible to communicate with the Wi-Gig access point 103, the control unit 211 may execute the coupling sequence for coupling to the Wi-Gig access point 103 at S816.

At S817, the control unit 211 starts communication with the Wi-Gig access point 103. For example, the control unit 211 may transfer a large amount of data of a movie file or the like designated from the user and having a resolution of 4K or 8K through the Wi-Gig access point 103. Further, the control unit 211 measures the radio wave intensity of a radio wave within a period within which the coupling to the Wi-Gig access point 103 is kept. Then, the control unit 211 stores, in the storage unit 212, a maximum value and a minimum value of the radio wave intensity of a Wi-Fi radio wave detected within the period within which the coupling to the Wi-Gig access point 103 is kept as communication period intensity information in an associated relationship with the identification ID of the Wi-Gig access point 103 during coupling.

At S818, the control unit 211 decides whether or not the communication period intensity information stored in the storage unit 212 is to be transmitted to the Wi-Fi access point 102. For example, if the data communication with the Wi-Gig access point 103 is completed, the control unit 211 may decide that the communication period intensity information is to be transmitted to the Wi-Fi access point 102. Alternatively, for example, when the maximum value of the radio wave intensity of the communication period intensity information stored in the storage unit 212 is updated to a higher value or the minimum value is updated to a lower value, the control unit 211 may decide that the communication period intensity information is to be transmitted to the Wi-Fi access point 102.

At S819, the control unit 211 transmits the communication period intensity information to the Wi-Fi access point 102. At S820, the control unit 211 decides whether or not the radio wave intensity of Wi-Gig falls below a decoupling threshold value of Wi-Gig. It is to be noted that the decoupling threshold value of Wi-Gig may be set, for example, to a value such that, if the radio wave intensity is equal to or higher than the decoupling threshold value, communication of Wi-Gig may be executed stably. If the radio wave intensity of Wi-Gig does not fall below the decoupling threshold value of Wi-Gig (NO at S820), the processing advances to S817. On the other hand, if the radio wave intensity of Wi-Gig falls below the decoupling threshold value of Wi-Gig (YES at S820), the processing returns to S813.

As described in the description of processes with reference to FIGS. 7 and 8, for example, when the portable terminal 101 enters in a transmission direction of a beam in which a Wi-Gig access point 103 exists, the control unit 211 of the portable terminal 101 receives an entering notification from the Wi-Fi access point 102. Then, for example, when the entering notification is received, the control unit 211 decides whether or not the radio wave intensity of Wi-Fi is within the decision range between the upper limit threshold value and the lower limit threshold value of the radio wave intensity included in the entering notification. Then, if the radio wave intensity of Wi-Fi is within the decision range, the control unit 211 changes over the Wi-Gig communication unit 214 or the module of Wi-Gig to a reception state and couples to the Wi-Gig access point 103 by Wi-Gig communication. Accordingly, with the processes according to the embodiment, the control unit 211 may execute detection of a Wi-Gig communication area 113 of Wi-Gig with low power consumption using a received entering notification based on beam forming and a radio wave intensity of Wi-Fi.

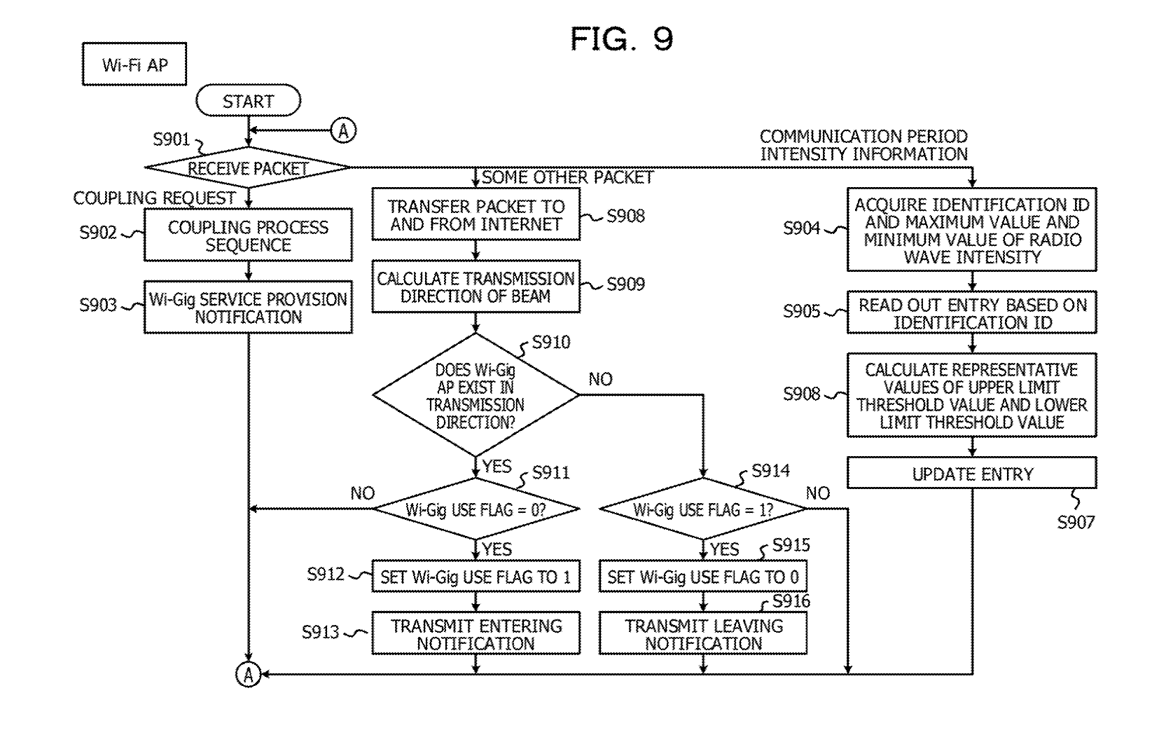

It is to be noted that, in the operation flow of FIG. 7 and the processes at S810 and S811 of FIG. 8, the control unit 211 of the portable terminal 101 operates, for example, as the decision unit 261. Further, in the process at S816 of FIG. 8, the control unit 211 of the portable terminal 101 operates, for example, as the starting unit 262. In the processes at S817 to S820 of FIG. 8, the control unit 211 of the portable terminal 101 operates, for example, as the transmission unit 263.

<Process of Wi-Fi Access Point> FIG. 9 is a flow chart exemplifying a Wi-Fi communication coupling process executed by a Wi-Fi controlling unit of a Wi-Fi access point. The Wi-Fi controlling unit of the Wi-Fi access point illustrated by reference to FIG. 9 may be the Wi-Fi controlling unit 221 of the Wi-Fi access point 102 depicted in FIG. 2. The Wi-Fi controlling unit 221 of the Wi-Fi access point 102 may execute the Wi-Fi communication coupling process of FIG. 9 when the Wi-Fi access point 102 is activated.

At S901, the Wi-Fi controlling unit 221 of the Wi-Fi access point 102 receives a packet from the portable terminal 101. If the received packet is a coupling request, the processing advances to S902, at which the Wi-Fi controlling unit 221 controls the Wi-Fi transmission and reception unit 224 to execute a coupling process sequence to establish coupling to the portable terminal 101. Further, at S902, the Wi-Fi controlling unit 221 may set, for example, using a MAC address as the portable terminal identification ID for identifying the portable terminal 101 to which the communication is established, the Wi-Gig use flag to 0 and register an entry into the portable terminal information 600. It is to be noted that MAC is an abbreviation of Media Access Control address. Further, if the coupling to the portable terminal 101 is cut, the Wi-Fi controlling unit 221 may delete the entry of the portable terminal information 600 corresponding to the portable terminal 101.

At S903, the control unit 211 transmits a Wi-Gig service provision notification indicating that the portable terminal 101 is in an area in which the Wi-Fi access point 102 provides a service by Wi-Gig communication to the coupled portable terminal 101. Thereafter, the processing returns to S901.

On the other hand, if the received packet is communication period intensity information at S901, the processing advances to S904. At S904, the Wi-Fi controlling unit 221 acquires an identification ID of the Wi-Gig access point 103 and a maximum value and a minimum value of the radio wave intensity from the received communication period intensity information. At S905, the Wi-Fi controlling unit 221 reads out an entry corresponding to the acquired identification ID of Wi-Gig access point 103 from the radio wave intensity management information 500.

At S906, the Wi-Fi controlling unit 221 calculates a representative value of the upper limit threshold value and a representative value of the lower limit threshold value of the radio wave intensity using the information of the upper limit threshold value, the lower limit threshold value, and the coupling time number of the entry read out from the radio wave intensity management information 500 and the information of the maximum value and the minimum value of the communication period intensity information. In one example, the control unit 211 may calculate average values in accordance with the following expressions as the representative values of the upper limit threshold value and the lower limit threshold value.

Average value of upper limit threshold value=(upper limit threshold value×coupling time number+maximum value)/(coupling time number+1)

Average value of lower limit threshold value=(lower limit threshold value×coupling time number+minimum value)/(coupling time number+1)

It is to be noted that the representative values may not limited to the average values and may be other values such as medians, maximum values, minimum values, or modes.

At S907, the Wi-Fi controlling unit 221 updates the values of the entry read out from the radio wave intensity management information 500 and read out at S905. For example, the Wi-Fi controlling unit 221 may update the upper limit threshold value of the entry read out at S905 to the representative value of the upper limit threshold value calculated at S906 or may update the lower limit threshold value to the representative value of the lower limit threshold value calculated at S906. Further, the Wi-Fi controlling unit 221 may increase the coupling time number of the entry read out at S905 by one. After the values of the entry are updated, the processing returns to S901.

On the other hand, if the packet received at S901 is neither a coupling request nor communication period intensity information but is some other packet, the processing advances to S908. At S908, the Wi-Fi controlling unit 221 transfers, for example, the received packet to or from the Internet 105 through the controller 104. At S909, the Wi-Fi controlling unit 221 calculates a transmission direction of a Wi-Fi radio wave to be transmitted by beam forming to the coupled portable terminal 101.

At S910, the Wi-Fi controlling unit 221 decides whether or not a Wi-Gig access point 103 exists in the calculated transmission direction of the beam of Wi-Fi. For example, if the transmission direction of the beam of Wi-Fi coincides with the angle of some entry registered in the radio wave intensity management information 500, the Wi-Fi controlling unit 221 may decide that a Wi-Gig access point 103 exists in the transmission direction of the beam. If a Wi-Gig access point 103 exists in the transmission direction of the beam by beam forming at S910 (YES at S910), the processing advances to S911.

At S911, the Wi-Fi controlling unit 221 refers to the portable terminal information 600 to decide whether or not the Wi-Gig use flag of the entry corresponding to the portable terminal 101 of the transmission source of the reception packet is 0. If the Wi-Gig use flag is not 0 (NO at S911), the processing returns to S901. On the other hand, if the Wi-Gig use flag is 0 (YES at S911), the processing advances to S912, at which the Wi-Fi controlling unit 221 sets the Wi-Gig use flag to 1. At S913, the Wi-Fi controlling unit 221 transmits an entering notification including the identification ID corresponding to the Wi-Gig access point 103 existing in the direction of the transmission beam and the decision range of the radio wave intensity to the portable terminal 101 of the transmission source of the packet, whereafter the processing returns to S901.

On the other hand, if a Wi-Gig access point 103 does not exist in the transmission direction of the beam by beam forming at S910 (NO at S910), the processing advances to S914. At S914, the Wi-Fi controlling unit 221 decides whether or not the Wi-Gig use flag is 1. If the Wi-Gig use flag is not 1 (NO at S914), the processing returns to S901. On the other hand, if the Wi-Gig use flag is 1 (YES at S914), the processing advances to S915, at which the Wi-Fi controlling unit 221 sets the Wi-Gig use flag to 0. At S916, the Wi-Fi controlling unit 221 transmits a leaving notification indicating that the portable terminal 101 is displaced from the direction in which the Wi-Gig access point 103 exists to the portable terminal 101 of the transmission source of the packet. Thereafter, the processing returns to S901.

As described above, in the first embodiment, the Wi-Fi controlling unit 221 of the Wi-Fi access point 102 transmits a radio wave by beam forming to the portable terminal 101. Then, when the transmission direction of a radio wave by beam forming becomes coincident with the direction in which a Wi-Gig access point 103 exists, the Wi-Fi controlling unit 221 transmits an entering notification for the notification that the portable terminal 101 enters in the direction in which the Wi-Gig access point 103 exists to the portable terminal 101. The entering notification includes an identification ID of the Wi-Gig access point 103 existing in the direction and information of a decision range for the Wi-Fi radio wave intensity corresponding to the Wi-Gig communication area 113 of the Wi-Gig access point 103. Therefore, the portable terminal 101 receiving the entering notification may detect that the portable terminal 101 enters in the transmission direction of the beam in which the Wi-Gig access point 103 exists. Further, the portable terminal 101 may decide whether or not the portable terminal 101 enters the Wi-Gig communication area 113 using a radio wave of Wi-Fi from an upper limit threshold value and a lower limit threshold value for the notified radio wave intensity.

Accordingly, with the first embodiment, the power consumption of the portable terminal 101 for detection of a Wi-Gig communication area 113 may be reduced.

Further, with the first embodiment, the portable terminal 101 notifies the Wi-Fi access point 102 of communication period intensity information including a maximum value and a minimum value of the radio wave intensity of Wi-Fi detected during a period within which the portable terminal 101 remains coupled to the Wi-Gig access point 103. Therefore, the Wi-Fi access point 102 may update values of an entry of the radio wave intensity management information 500 based on the communication period intensity information. Then, by updating the values of the entry using information of the radio wave intensity of Wi-Fi in a situation in which the portable terminal 101 actually remains coupled to the Wi-Gig access point 103, the accuracy in detection of a Wi-Gig communication area 113 using a radio wave of Wi-Fi may be enhanced.

<Second Embodiment> In the example of FIG. 3 of the first embodiment, a case is exemplified in which, after the portable terminal 101 couples to a Wi-Gig access point 103, the portable terminal 101 acquires a file of a download target from the Internet 105 through the controller 104. However, the embodiment is not limited to this. For example, it seems a possible idea to download a file of a download target to the controller 104 in advance before the portable terminal 101 couples to a Wi-Gig access point 103. Further, from among a plurality of Wi-Gig access points 103 included, for example, in a Wi-Fi communication area 112 of Wi-Fi, a Wi-Gig access point 103 to which the user may establish coupling in high possibility is specified. Then, it seems a possible idea to transfer, before the portable terminal 101 couples to the Wi-Gig access point 103, data downloaded from the controller 104 to the specified Wi-Gig access point 103. Then, by transferring data of a download target to the controller 104 or a Wi-Gig access point 103 in advance before the portable terminal 101 coupling to the Wi-Gig access point 103 in this manner, the time period for downloading may be reduced. In the following, a second embodiment is described.

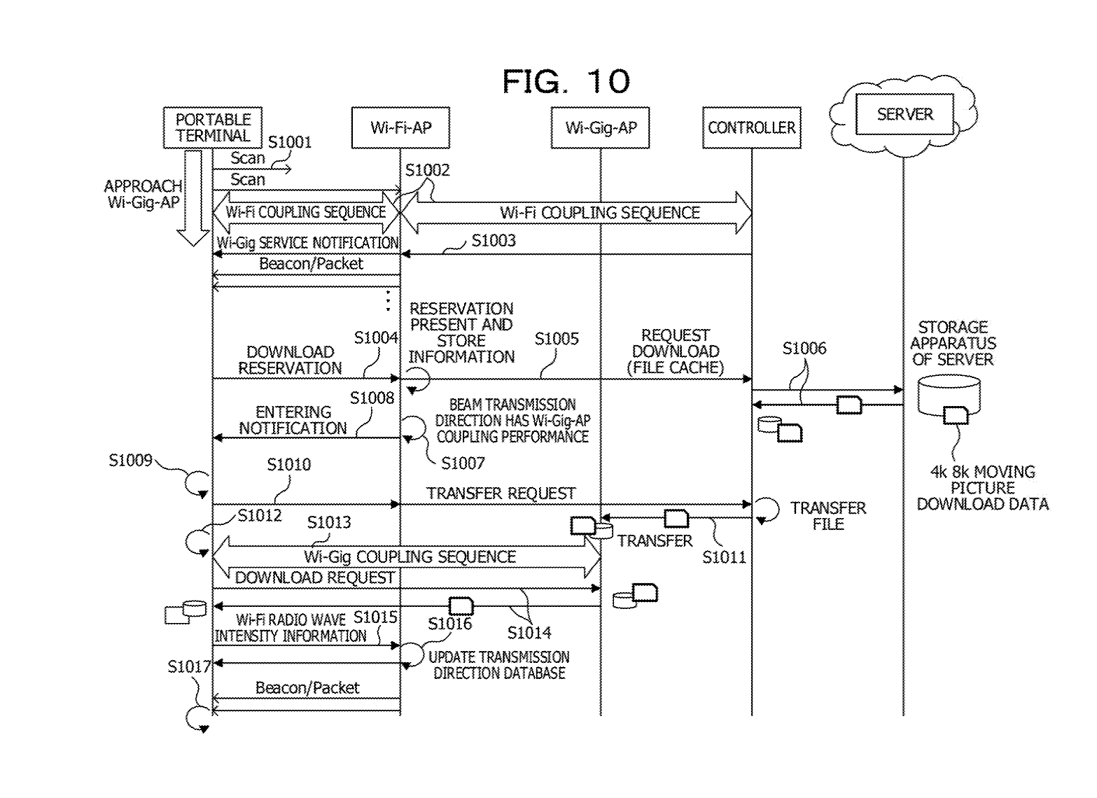

FIG. 10 is a sequence diagram exemplifying a sequence of a communication coupling process according to the second embodiment. It is to be noted that processes at S1001 to S1003 of FIG. 10 may be similar to the processes at S301 to S303 of FIG. 3. Then at S1004, the portable terminal 101 transmits a download reservation notification for reserving downloading of a large amount of data of a movie file or the like designated from a user and having a resolution of 4K or 8K to the Wi-Fi access point 102. The download reservation notification may include information, for example, of a portable terminal identification ID (for example, a MAC address) for identifying a portable terminal that requests downloading and a uniform resource locator (URL) or an interne protocol (IP) address in which a file of the download target is stored. At S1005, the Wi-Fi access point 102 stores, for example, the information of the download reservation notification into the Wi-Fi storage unit 222 and transmits a download reservation notification to the controller 104 to request the controller 104 to download and cache the file.

At S1006, the controller 104 downloads data from the server 206 located, for example, at a remote place and caches the data into the controller storage unit 242. At S1007, while the Wi-Fi access point 102 communicates with the portable terminal 101 using beam forming, the Wi-Fi access point 102 decides whether or not the transmission direction of the beam is a direction in which a Wi-Gig access point 103 exists. Then at S1008, when the transmission direction of the beam becomes coincident with the direction in which a Wi-Gig access point 103 exists, the Wi-A access point 102 transmits an entering notification to the portable terminal 101. The entering notification may include the identification ID of the Wi-Gig access point 103 existing in the transmission direction of the beam and a decision range of the radio wave intensity of Wi-Fi.

At S1009, after the portable terminal 101 receives the entering notification, the portable terminal 101 monitors the radio wave intensity of Wi-Fi and decides whether or not the radio wave intensity is within the decision range of the radio wave intensity included in the entering notification. Further at S1010, the portable terminal 101 transmits a transfer notification including the identification ID of the Wi-Fi access point 102 existing in the transmission direction of the beam, which made an opportunity of the notification of the entering notification, to the controller 104 through the Wi-Fi access point 102. At S1011, the controller 104 transfers the data cached into the controller storage unit 242 at S1006 to the bili-Gig access point 103 identified with the identification ID included in the transfer notification.

At S1012, the portable terminal 101 continuously executes the decision at S1009 of whether or not the radio wave intensity of Wi-Fi is within the decision range. Then, if the radio wave intensity of Wi-Fi is within the decision range, the portable terminal 101 turns, for example, on the Wi-Gig communication unit 214 or the module of Wi-Gig to establish a reception state in which a radio wave of Wi-Gig may be received at S1013. In this case, the portable terminal 101 is located already in the Wi-Gig communication area 113 of the Wi-Gig access point 103 with a high possibility, and at S1013, the portable terminal 101 may detect, for example, a Wi-Gig access point 103 and establish coupling to the Wi-Gig access point 103.

At S1014, the portable terminal 101 transmits a download request to the coupled Wi-Gig access point 103 and downloads the data transferred to the Wi-Gig access point 103 at S1011. Processes at the following S1015 to S1017 may be executed similarly, for example, to the processes at S310 to S312 of FIG. 3.

As described above, in the sequence of the communication coupling process of FIG. 10, after the portable terminal 101 couples to a Wi-Fi access point 102, the portable terminal 101 issues a download reservation notification to the controller 104. Therefore, the controller 104 may cache data of a download target into the controller storage unit 242 in advance. Accordingly, when the data of the download target are downloaded to the portable terminal 101, the time period for downloading of data from the server 206 to the controller 104 may be reduced.

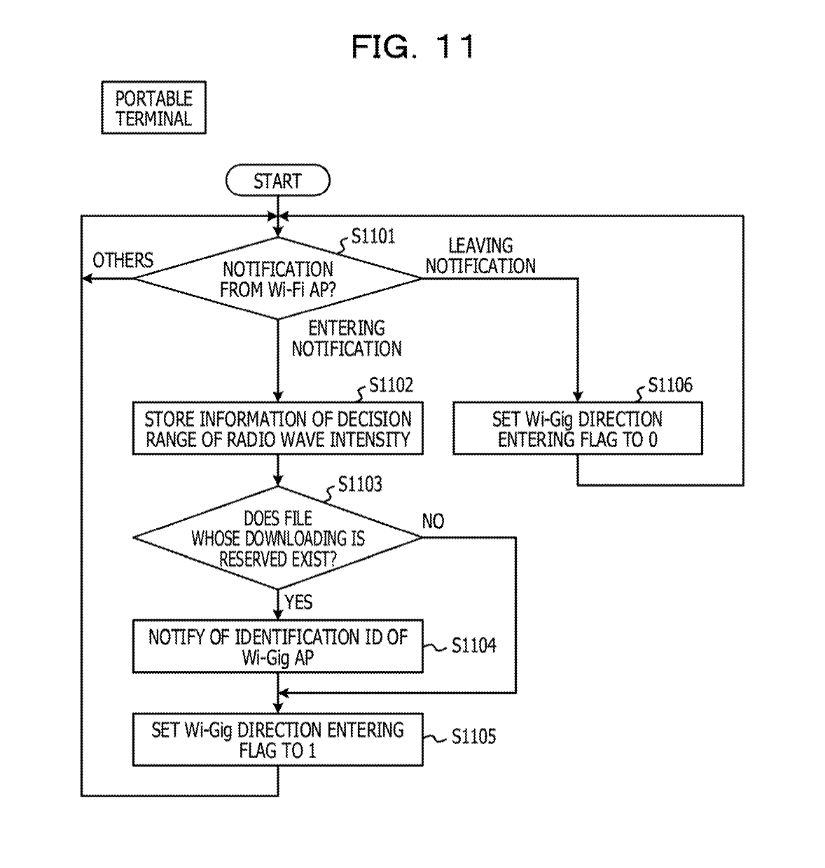

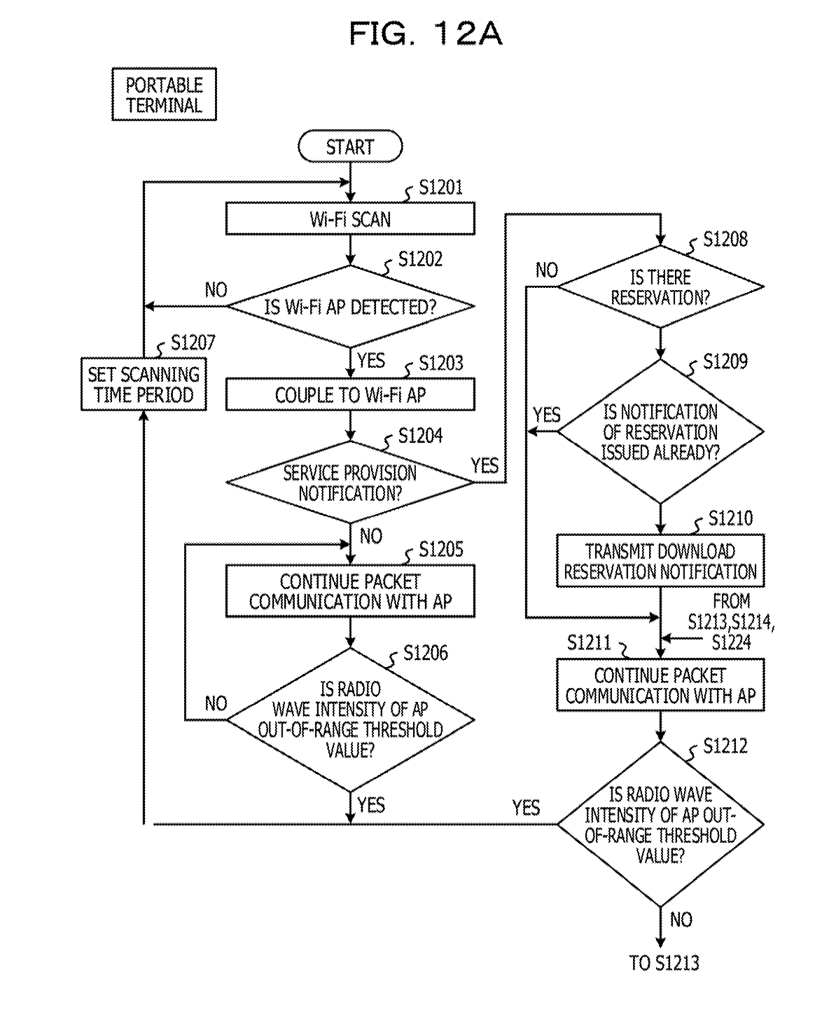

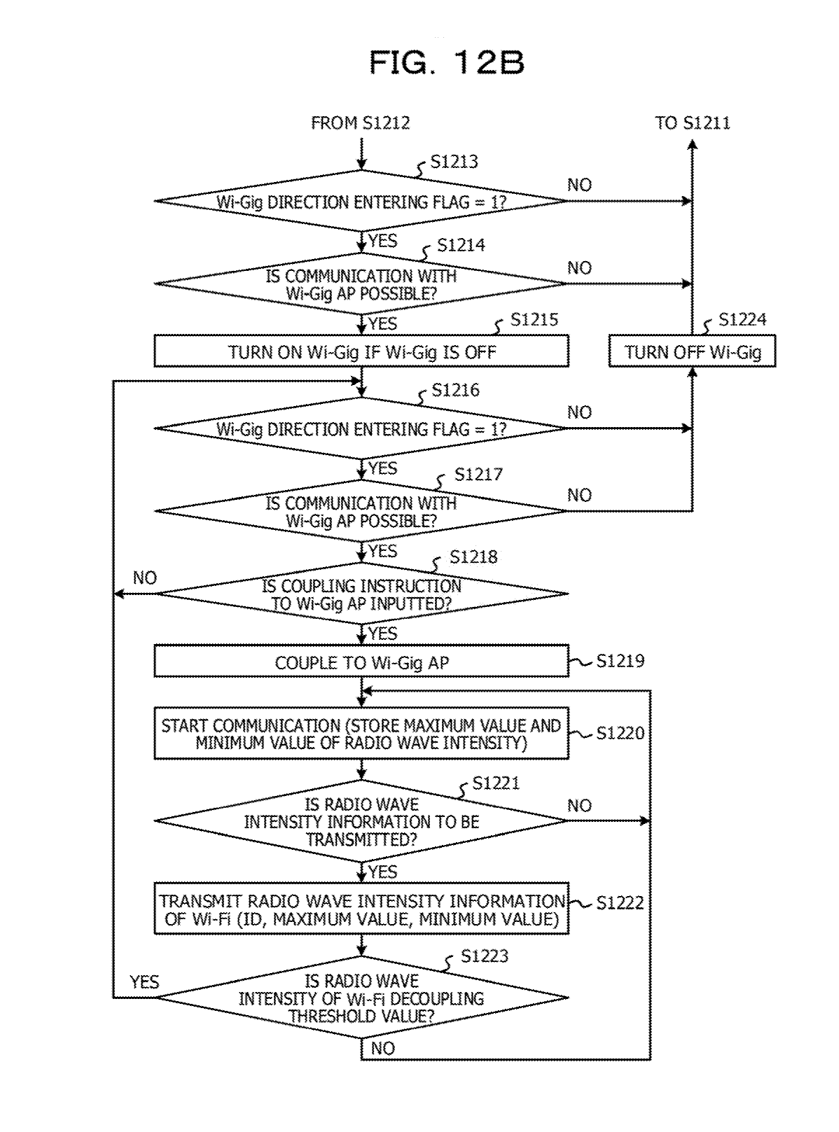

Further, if the portable terminal 101 receives an entering notification and a Wi-Gig access point 103 to which coupling may be established with a high possibility is specified, the portable terminal 101 requests the controller 104 to transfer data to the Wi-Gig access point 103. Accordingly, when the data of the download target are downloaded to the portable terminal 101, the time period for transfer of data from the controller 104 to the Wi-Gig access point 103 may be reduced. In the following, details of a process corresponding to the sequence according to the second embodiment described above are exemplified.

<Process of Portable Terminal> FIG. 11 is a flow chart exemplifying a Wi-Gig direction entering flag setting process according to the second embodiment. The control unit 211 of the portable terminal 101 may start the Wi-Gig direction entering flag setting process of FIG. 11 when the control unit 211 receives, for example, a Wi-Gig service provision notification from the Wi-Fi access point 102 coupled to the portable terminal 101 in an operation flow of FIG. 12 hereinafter described.

It is to be noted that the processes at S1101 and S1102 of FIG. 11 may correspond to the processes at S701 and S702 of FIG. 7, respectively, and, for example, the control unit 211 may execute, at S1101 and S1102 processes similar to the processes at S701 and S702 of FIG. 7.

Further, at S1103, the control unit 211 decides whether or not there is a file whose downloading is reserved from a user. If there is no file whose downloading is reserved (NO at S1103), the processing advances to S1105. On the other hand, if there is a file whose downloading is reserved (YES at S1103), the processing advances to S1104. At S1104, the control unit 211 issues a transfer notification including a portable terminal identification ID for identifying the portable terminal 101 and an identification ID of the Wi-Gig access point 103 conveyed by the entering notification to the controller 104 through the Wi-Fi access point 102. It is to be noted that the controller 104 receiving the notification may transfer, for example, a file cached in an associated relationship with the portable terminal identification ID to the Wi-Gig access point 103 identified with the identification ID.

Processes at S1105 and S1106 may correspond to the processes at S703 and S704 of FIG. 7, respectively, and, for example, the control unit 211 may execute processes similar to the processes at S703 and S704 of FIG. 7 as processes at S1105 and S1106.

By the processes of FIG. 11 described above, before the portable terminal 101 couples to the Wi-Gig access point 103, the portable terminal 101 may transfer a file cached, for example, in the controller 104 to a Wi-Gig access point 103 that may become a coupling destination with a high possibility.

FIG. 12 is a flow chart exemplifying a communication coupling process according to the second embodiment. The control unit 211 may start the communication coupling process of FIG. 12, for example, when the portable terminal 101 is activated.

Processes at S1201 to S1207 may correspond to the processes at S801 to S807 of FIG. 8, respectively. For example, at S1201 to S1207, the control unit 211 may execute processes similar to the processes at S801 to S807.

At S1208, the control unit 211 decides whether or not a reservation instruction for downloading of a file is inputted. It is to be noted that the reservation instruction for downloading of a file may be inputted by a user designating a file of a download target through software such as a browser. If a reservation instruction for downloading of a file is not inputted (NO at S1208), the processing advances to S1211. On the other hand, if a reservation instruction for downloading of a file is inputted (YES at S1208), the processing advances to S1209. At S1209, the control unit 211 decides whether or not a notification of the reservation of downloading is issued already to the Wi-Fi access point 102. If a notification of the reservation of downloading is issued already (YES at S1209), the processing advances to S1211. On the other hand, if a notification of the reservation of downloading is not issued as yet (NO at S1209), the processing advances to S1210. At S1210, the control unit 211 transmits a download reservation notification for reserving downloading of a file to the Wi-Fi access point 102.

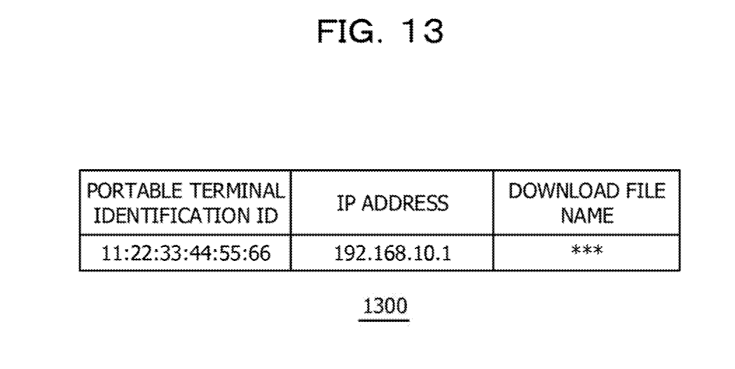

FIG. 13 is a view exemplifying a download reservation notification according to the second embodiment. A download reservation notification 1300 depicted in FIG. 13 may include, for example, a portable terminal identification ID, an IP address, and a download file name. The portable terminal identification ID may be information for identifying the portable terminal 101 from which the download reservation notification 1300 is issued. The portable terminal identification ID may be, for example, a MAC address of the portable terminal 101. The IP address may be an IP address, for example, of the server 206 that retains the file to be downloaded. The download file name is a file name, for example, of the file to be downloaded.

It is to be noted that, if the Wi-Fi access point 102 receives, for example, a download reservation notification 1300, the Wi-Fi access point 102 stores information included in the download reservation notification 1300 into the Wi-Fi storage unit 222. Further, the Wi-Fi access point 102 transmits the download reservation notification 1300 to the controller 104 to instruct the controller 104 to download and cache the file. The controller 104 receiving the download reservation notification 1300 downloads a file of a file name designated by the download file name, for example, from the server 206 of the IP address designated by the download reservation notification 1300. Then, the controller 104 caches the downloaded file into the controller storage unit 242 in an associated relationship with the portable terminal identification ID.

Processes at the following S1211 to S1224 may correspond to the processes at S808 to S821 of FIG. 8, respectively. For example, at S1211 to S1224, the control unit 211 may execute processes similar to the processes at S808 to S821.

As described above, according to the operation flow of FIG. 12, when the control unit 211 couples to and starts communication with a Wi-Fi access point 102, if there is a download reservation of a file, the control unit 211 instructs the controller 104 to download the file. Therefore, in comparison with an alternative case in which, for example, a file is downloaded from the server 206 after coupling to the Wi-Gig access point 103 is established, the time period for downloading data from the server 206 to the controller 104 may be reduced.

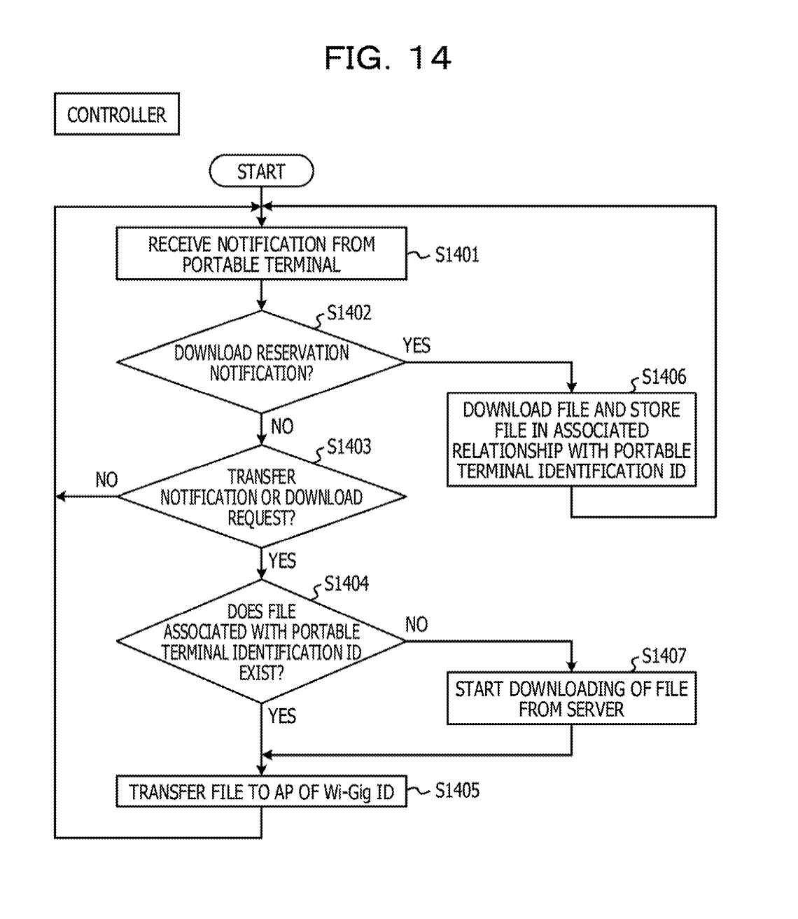

It is to be noted that, in the processes at S1101, S1102, S1105, and S1106 of FIG. 11 and the processes at S1213 and S1214 of FIG. 12, the control unit 211 of the portable terminal 101 operates, for example, as the decision unit 261. Further, in the process at S1219 of FIG. 12, the control unit 211 of the portable terminal 101 operates, for example, as the starting unit 262. In the processes at S1219 to S1223 of FIG. 12, the control unit 211 of the portable terminal 101 operates, for example, as the transmission unit 263. In the processes at S1208 to S1210 of FIG. 12, the control unit 211 of the portable terminal 101 operates, for example, as the reservation unit 264. In the processes at S1103 and S1104 of FIG. 11, the control unit 211 of the portable terminal 101 operates, for example, as the instruction unit 265.

<Process of Wi-Fi Access Point> Also in the second embodiment, the Wi-Fi controlling unit 221 of the Wi-Fi access point 102 may execute the Wi-Fi communication coupling process of FIG. 9.

<Process of Controller> FIG. 14 is a flow chart exemplifying a file transmission process executed by a controller controlling unit of a controller according to the second embodiment. The controller illustrated by reference to FIG. 14 may be the controller 104 illustrated by reference to FIG. 10. A controller controlling unit 241 of the controller 104 may execute, for example, a Wi-Fi coupling sequence and then start, after coupling between the portable terminal 101 and the controller 104 is established, the operation flow of FIG. 14.

At S1401, the controller controlling unit 241 of the controller 104 receives a notification from the portable terminal 101 through the Wi-Fi access point 102. At S1402, the controller controlling unit 241 decides whether or not the notification is a download reservation notification 1300. If the notification is not a download reservation notification 1300 (NO at S1402), the processing advances to S1403. At S1403, the controller controlling unit 241 decides whether or not the notification is a transfer notification or a download request. It is to be noted that the download request may be, for example, a notification for requesting for downloading of a file while there is no download reservation notification in advance and may include information similar to the download reservation notification 1300 of FIG. 13. If the notification is not any of a transfer notification and a download request (NO at S1403), the processing returns to S1401. On the other hand, if the notification is a transfer notification or a download request (YES at S1403), the processing advances to S1404.

At S1404, the controller controlling unit 241 decides whether or not a file associated with a portable terminal identification ID for identifying the portable terminal 101 included, for example, in a transfer notification or a download request is cached in the controller storage unit 242. If a file associated with the portable terminal identification ID is cached in the controller storage unit 242 (YES at S1404), the processing advances to S1405. It is to be noted that, if a file is cached in the controller storage unit 242, the notification received at S1401 is, for example, a transfer notification.

At S1405, the controller controlling unit 241 transfers a file associated with the portable terminal identification ID in an associated relationship with the portable terminal identification ID, for example, to a Wi-Gig access point 103 identified with the identification ID included in the transfer notification. Thereafter, the processing returns to S1401.

On the other hand, if a file associated with the portable terminal identification ID is not cached in the controller storage unit 242 (NO at S1404), the processing advances to S1407. In this case, the notification received at S1401 is, for example, a download request. At S1407, the controller controlling unit 241 starts downloading of a file, whose download request is received, from the server 206. Then, the controller controlling unit 241 transfers the downloaded file to the Wi-Gig access point 103 at S1405.

On the other hand, if the notification is a download reservation notification 1300 at S1402 (YES at S1402), the processing advances to S1406. At S1406, the controller controlling unit 241 downloads a file designated by the download reservation notification 1300 from the server 206 and stores the file in an associated relationship with the portable terminal identification ID of the download reservation notification 1300 into the controller storage unit 242.

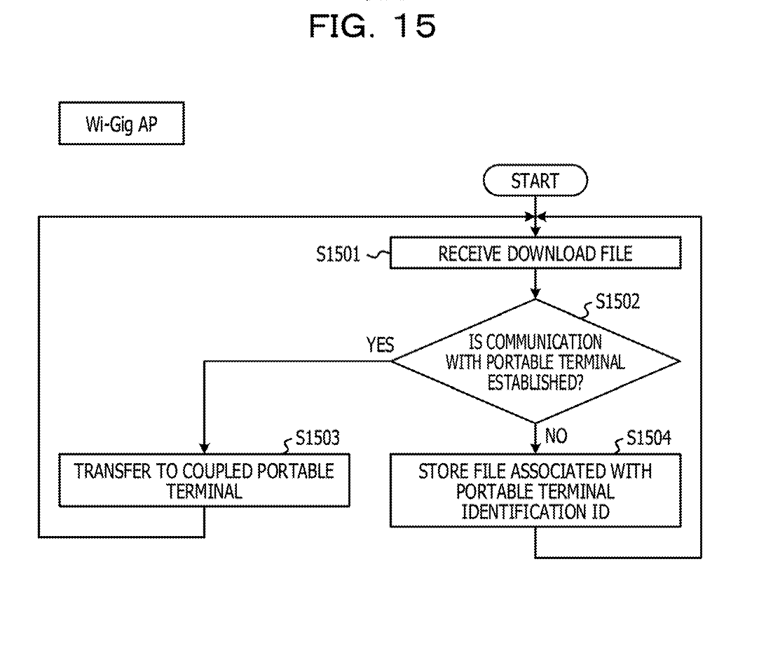

As described above, according to the operation flow of FIG. 14, if the controller controlling unit 241 receives a download reservation notification 1300 from a portable terminal 101, the controller controlling unit 241 downloads a file designated by the download reservation notification 1300 and stores the file into the controller storage unit 242. Then, if the controller controlling unit 241 receives a transfer notification, the controller controlling unit 241 transfers the file stored in the controller storage unit 242 to a Wi-Gig access point 103. Here, the Wi-Gig access point 103 to which the file is transferred is a Wi-Gig access point 103 located in the transmission direction of a beam in Wi-Fi communication of the portable terminal 101. Accordingly, this Wi-Gig access point 103 is a Wi-Gig access point 103 to which the portable terminal 101 may be coupled with a high possibility. Therefore, in comparison with an alternative case in which a file cached in the controller 104 is transferred to the Wi-Gig access point 103 after portable terminal 101 couples to the Wi-Gig access point 103, the time period for downloading of the file may be reduced.

<Process of Wi-Gig Access Point> FIG. 15 is a flow chart exemplifying a file transmission process executed by a Wi-Gig controlling unit of a Wi-Gig access point according to the second embodiment. The Wi-Gig access point illustrated by reference to FIG. 15 may be the Wi-Gig access point 103 illustrated by reference to FIG. 10. A Wi-Gig controlling unit 231 of the Wi-Gig access point 103 may start the file transmission process of FIG. 15, for example, in response to activation of the Wi-Gig access point 103.

At S1501, the Wi-Gig controlling unit 231 receives a file associated with a portable terminal identification ID transferred thereto from the controller 104. At S1502, the Wi-Gig controlling unit 231 decides whether or not communication is established already with a portable terminal 101 identified with the portable terminal identification ID associated with the file. If communication with the portable terminal 101 is already established (YES at S1502), the processing advances to S1503. At S1503, the Wi-Gig controlling unit 231 transfers the file transmitted thereto from the controller 104 to the coupled portable terminal 101. Then, the processing returns to S1501.

On the other hand, if communication with the portable terminal 101 is not established as yet (NO at S1502), the processing advances to S1504. At S1504, the Wi-Gig controlling unit 231 stores a file associated with the portable terminal identification ID transmitted thereto from the controller 104 into the Wi-Gig storage unit 232. Then, the processing returns to S1501.

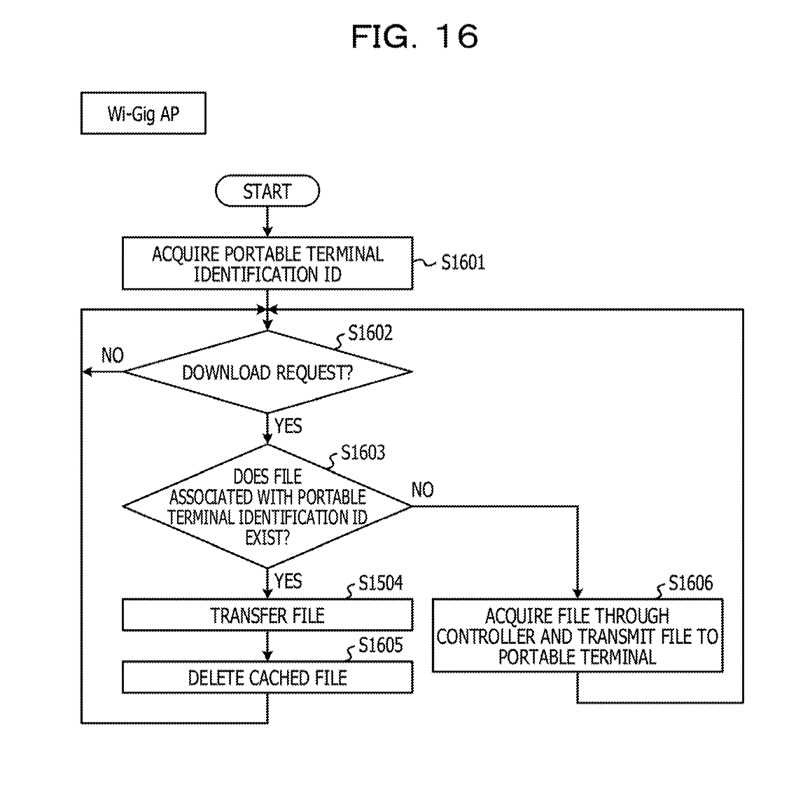

Further, FIG. 16 is a flow chart exemplifying a second file transmission process executed by a Wi-Gig controlling unit of a Wi-Gig access point according to the second embodiment. The Wi-Gig controlling unit of the Wi-Gig access point illustrated by reference to FIG. 16 may be the Wi-Gig controlling unit 231 of the Wi-Gig access point 103 illustrated by reference to FIG. 15. The Wi-Gig controlling unit 231 of the Wi-Gig access point 103 may start the second file transmission process of FIG. 16, for example, after coupling to the portable terminal 101 is established.

At S1601, the Wi-Gig controlling unit 231 of the Wi-Gig access point 103 acquires the portable terminal identification ID of the coupled portable terminal 101. At S1602, the Wi-Gig controlling unit 231 decides whether or not a download request is received from the portable terminal 101. If the notification from the portable terminal 101 is not a downward request (NO at S1602), the processing repeats the process at S1602. On the other hand, if the notification from the portable terminal 101 is a download request at S1602 (YES at S1602), the processing advances to S1603.

At S1603, the Wi-Gig controlling unit 231 decides whether or not a file associated with the portable terminal identification ID acquired at S1601 is stored in the Wi-Gig storage unit 232. If a file associated with the portable terminal identification ID is stored in the Wi-Gig storage unit 232 (YES at S1603), the processing advances to S1604.

At S1604, the Wi-Gig controlling unit 231 transfers a file associated with the portable terminal identification ID stored in the Wi-Gig storage unit 232 to the portable terminal 101 from which the download request has been received. At S1605, the Wi-Gig controlling unit 231 deletes the file whose transfer is completed from the Wi-Gig storage unit 232, and the processing returns to S1602.

Further, if there is no file associated with the portable terminal identification ID in the Wi-Gig storage unit 232 at S1603 (NO at S1603), the processing advances to S1606. At S1606, the Wi-Gig controlling unit 231 acquires the file of the download target designated by the download request through the controller 104 and transmits the file to the portable terminal 101 using Wi-Gig communication. Thereafter, the processing returns to S1602.

As described hereinabove with reference to FIGS. 15 and 16, the Wi-Gig access point 103 may receive and store a file of a download target from the controller 104 before the Wi-Gig access point 103 couples to the portable terminal 101. Then, when coupling to the portable terminal 101 is established, the Wi-Gig access point 103 may transmit the stored file to the portable terminal 101. Accordingly, in comparison with an alternative case in which, after the portable terminal 101 couples to the Wi-Gig access point 103, a file is transmitted to the Wi-Gig access point 103, the time period for downloading of the file may be reduced. It is to be noted that, for example, the Wi-Gig controlling unit 231 may end the operation flows of FIGS. 15 and 16 if the coupling to the portable terminal 101 is cut.

As described above, in the second embodiment, a file of a download target may be stored in advance into the controller 104 or the Wi-Gig access point 103. Therefore, in addition to the advantageous effects demonstrated by the first embodiment, the second embodiment may reduce the time period for downloading of a file by the portable terminal 101.

It is to be noted that also it may seem recommendable as another embodiment to transfer a file of a download target cached in the controller 104 to all Wi-Gig access points 103 in a Wi-Fi communication area 112. In this case, since all Wi-Gig access points 103 may not wait a transfer notification from a portable terminal 101, data may be transferred earlier to the Wi-Gig access point 103. Meanwhile, with the second embodiment described above, since data are transmitted restrictively to a Wi-Gig access point 103 to which a user may establish coupling with a high possibility, increase of the communication load or increase of the amount of data to be stored into the Wi-Gig storage unit 232 may be suppressed.

Although the embodiments are exemplified as above, the present technology is not limited to the embodiments. For example, the operation flows described hereinabove are exemplary, and the present technology is not limited to the operation flows. If possible, the operation flows may be executed changing the process order or may further include a different process or processes, or some of the processes of the operation flows may be omitted.

Further, the embodiments described above exemplify a case in which a MAC address is used as the portable terminal identification ID. However, the present technology is not limited to this, and some other iformation capable of identifying a portable terminal 101 such as an IP address of the portable terminal 101 may be used in place of the MAC address.

Further, while the description of the embodiments given above takes wireless communication methods of Wi-Fi and Wi-Gig as examples, the present technology is not limited to the wireless communication methods of Wi-Fi and Wi-Gig. For example, Wi-Fi is one example of a first wireless communication method, and the Wi-Fi communication unit 213 is an example of a first communication unit. Meanwhile, Wi-Gig is an example of a second wireless communication method. The Wi-Gig communication unit 214 is an example of a second communication unit. Further, for example, any other wireless communication method may be used in place of Wi-Fi, and some other wireless communication method may be used in place of Wi-Gig. For example, where the communication distance of the first wireless communication method is longer than the communication distance of the second wireless communication method and an access point of the first wireless communication method communicates with the portable terminal 101 using beam forming, the embodiments may be applied. Further, for example, where the power consumption in communication of the second wireless communication method is higher than the power consumption in communication of the first wireless communication method, the advantageous effect of power saving according to the embodiments may be achieved.

Further, in the embodiments described above, a plurality of Wi-Gig access points 103 may possibly exist in a certain beam direction of a Wi-Fi access point 102. In this case, the processes of the embodiments described above may be carried out by applying the embodiments such that the processes are executed individually for each of the Wi-Gig access points 103.

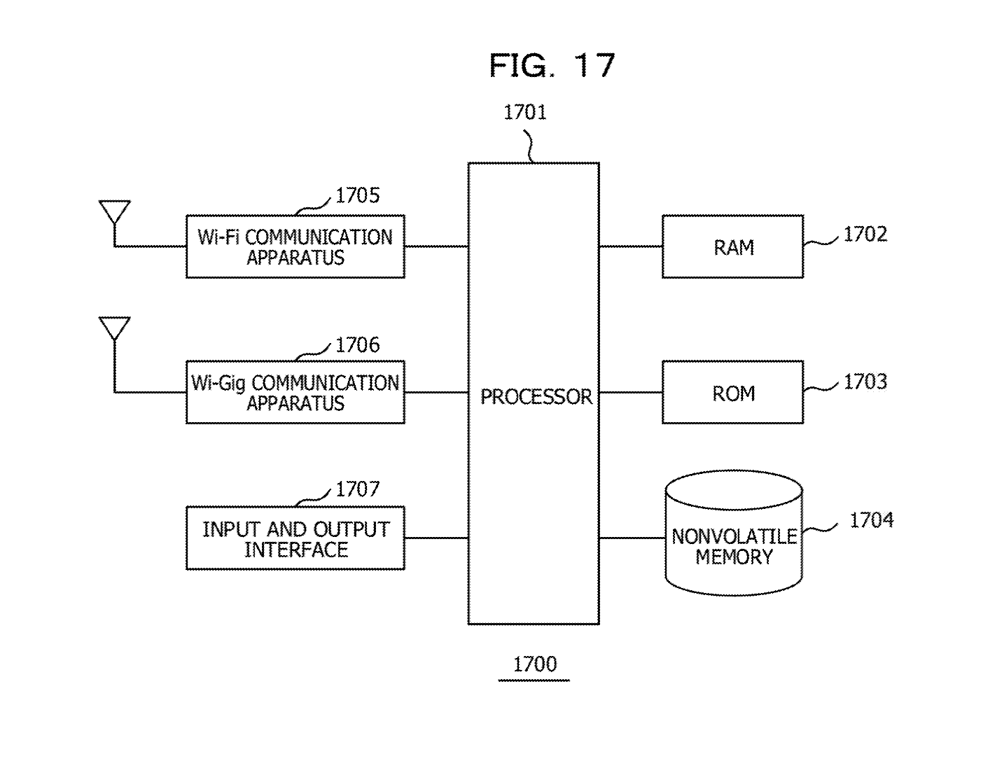

FIG. 17 is a block diagram depicting an example of a hardware configuration of a computer for implementing a portable terminal. The portable terminal illustrated by reference to FIG. 17 may be the portable terminal 101 depicted in FIG. 2. A computer 1700 depicted in FIG. 17 may be a communication apparatus such as a smartphone, a tablet terminal, a wearable terminal or the like, or a laptop computer. The computer 1700 includes a processor 1701, a RAM 1702, a ROM 1703, a nonvolatile memory 1704, a Wi-Fi communication apparatus 1705, a Wi-Gig communication apparatus 1706, and an input and output interface 1707. It is to be noted that RAM is an abbreviation of Random Access Memory. Meanwhile, ROM is an abbreviation of Read Only Memory. The RAM 1702 is, for example, a volatile memory and provides a working area to the processor 1701. The ROM 1703 is, for example, nonvolatile and stores an operating system (OS), pre-installed applications, system data and so forth. The nonvolatile memory 1704 is, for example, a flash memory. The nonvolatile memory 1704 stores, for example, applications, data of a user and so forth. For example, the storage unit 212 described above may include the RAM 1702, the ROM 1703, and the nonvolatile memory 1704. The processor 1701 may operate as the control unit 211, for example, by reading out a program stored in the nonvolatile memory 1704 into the RAM 1702 and executing the program. For example, the processor 1701 may operate as the decision unit 261, the starting unit 262, the transmission unit 263, the reservation unit 264, and the instruction unit 265 by reading out a program stored in the nonvolatile memory 1704 into the RAM 1702 and executing the program.

The Wi-Fi communication apparatus 1705 performs conversion, between an electric signal and a wireless signal in compliance with, for example, the communication standard of Wi-Fi, couples to a Wi-Fi access point 102 through an antenna in accordance with an instruction from the processor 1701, and communicates with the Wi-Fi access point 102. The Wi-Gig communication apparatus 1706 performs conversion between an electric signal and a wireless signal in compliance with, for example, the communication standard of Wi-Gig, couples to a Wi-Gig access point 103 through an antenna in accordance with an instruction from the processor 1701, and communicates with the Wi-Gig access point 103. The Wi-Fi communication apparatus 1705 operates, for example, as the Wi-Fi communication unit 213 described hereinabove. Further, the Wi-Gig communication apparatus 1705 operates, for example, as the Wi-Gig communication unit 214 described hereinabove.

The input and output interface 1707 may be, for example, an interface between an inputting apparatus and an outputting apparatus. The inputting apparatus is a device such as a touch panel that accepts an instruction from a user. The outputting apparatus is a displaying apparatus such as a display unit and an audio device such as a speaker. It is to be noted that the computer 1700 may further include some other apparatus such as a cellular communication apparatus for coupling to a cellular communication network.

The hardware configuration of the computer 1700 is not limited to that depicted in FIG. 17 and allows suitable change such as addition, replacement, or deletion of a component. For example, the computer 1700 may include a portable recording medium driving apparatus for driving a portable recording medium in addition to the components depicted in FIG. 17. The portable recording medium may be, for example, a secure digital (SD) card, a micro SD card or the like.

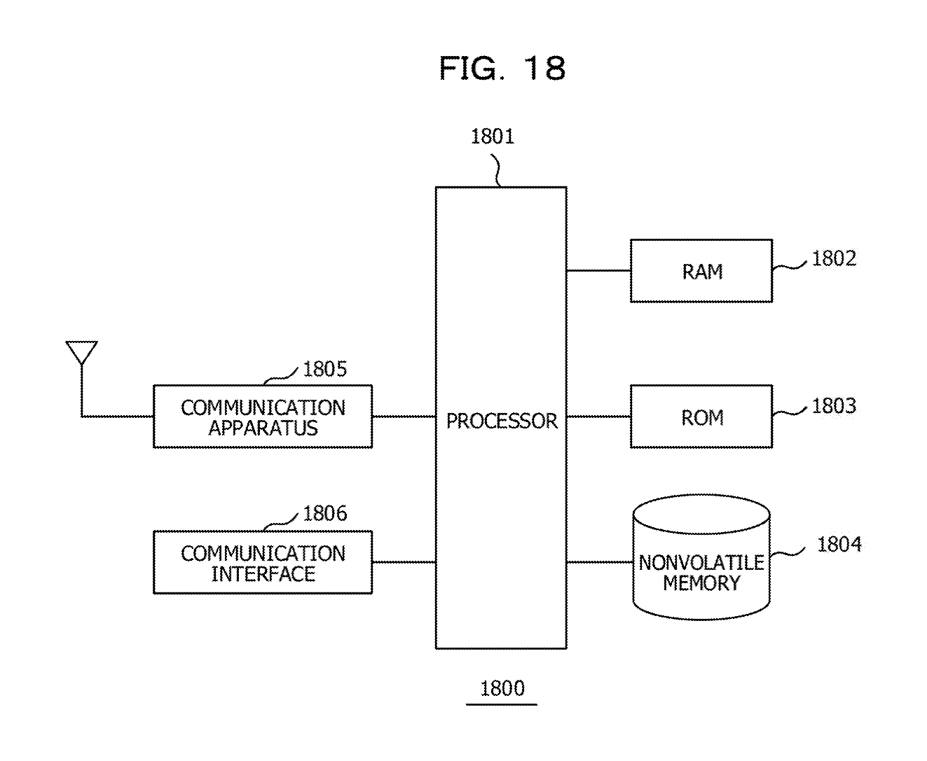

FIG. 18 depicts an example of a hardware configuration of a relay apparatus such as a Wi-Fi access point or a Wi-Gig access point. The Wi-Fi access point and the Wi-Gig access point illustrated by reference to FIG. 18 may be the Wi-Fi access point 102 and the Wi-Gig access point 103 depicted in FIG. 2. It is to be noted that, where a relay apparatus 1800 depicted in FIG. 18 is the Wi-Fi access point 102, the relay apparatus 1800 may operate as a first relay apparatus. On the other hand, where the relay apparatus 1800 is the Wi-Gig access point 103, the relay apparatus 1800 may operate as a second relay apparatus. The hardware configuration of the relay apparatus 1800 includes, for example, a processor 1801, a RAM 1802, a ROM 1803, a nonvolatile memory 1804, a communication apparatus 1805 and a communication interface 1806.

The RAM 1802 is, for example, a volatile memory and provides a working area to the processor 1801. The ROM 1803 is, for example, nonvolatile and stores an OS, pre-installed applications, system data and so forth. The nonvolatile memory 1804 is, for example, a flash memory. For example, the Wi-Fi storage unit 222 of the Wi-Fi access point 102 and the Wi-Gig storage unit 232 of the Wi-Gig access point 103 may include the RAM 1802, the ROM 1803, and the nonvolatile memory 1804. The processor 1801 may operate as the Wi-Fi controlling unit 221 or the Wi-Gig controlling unit 231, for example, by reading out a program stored in the ROM 1803 into the RAM 1802 and executing the program.

Further, for example, where the relay apparatus 1800 is the Wi-Fi access point 102, the communication apparatus 1805 performs conversion between an electric signal and a wireless signal in compliance with the communication standard of Wi-Fi and communicates with the portable terminal 101 in accordance with an instruction from the processor 1801. Meanwhile, where the relay apparatus 1800 is the Wi-Gig access point 103, the communication apparatus 1805 performs conversion between an electric signal and a wireless signal, for example, in compliance with the communication standard of Wi-Gig and communicates with the portable terminal 101 in accordance with an instruction from the processor 1801. The communication apparatus 1805 operates, for example, in the Wi-Fi access point 102, as the Wi-Fi transmission and reception unit 224 and operates, in the inti-Gig access point 103, as the Wi-Gig transmission and reception unit 234.

The communication interface 1806 may be, for example, a network interface card (NIC). The processor 1801 may couple to a local area network (LAN) or the like through the communication interface 1806 and transfer data, Where the relay apparatus 1800 is the Wi-Fi access point 102, the communication interface 1806 may operate, for example, as the communication interface 223. Meanwhile, where the relay apparatus 1800 is the Wi-Gig access point 103, the communication interface 1806 may operate as the communication interface 233.

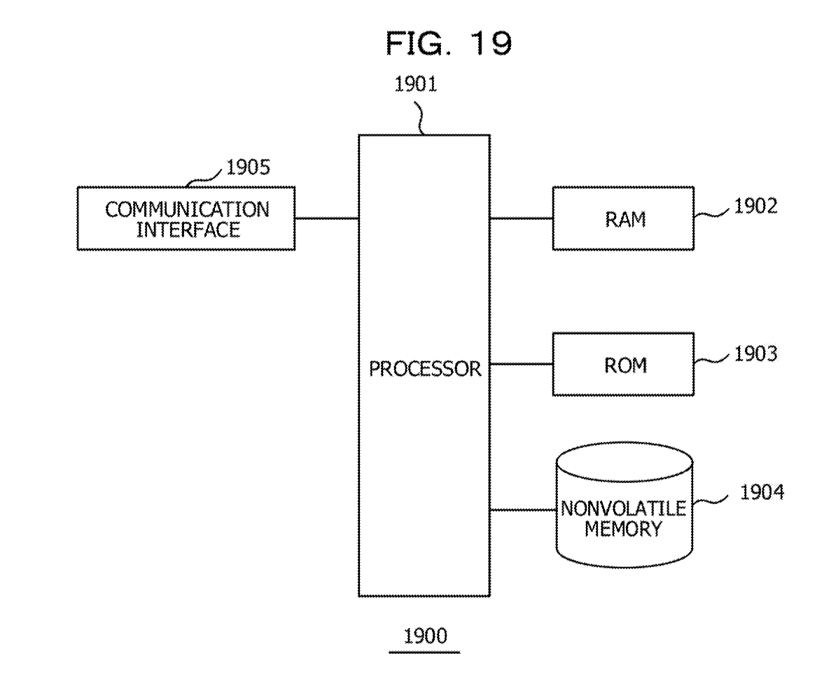

FIG. 19 is a block diagram exemplifying a hardware configuration of a management apparatus such as a controller. The controller illustrated by reference to FIG. 19 may be the controller 104 depicted in FIG. 2. A management apparatus 1900 depicted in FIG. 19 may be a computer for exclusive use or for universal use. The hardware configuration of the management apparatus 1900 includes, for example, a processor 1901, a RAM 1902, a ROM 1903, a nonvolatile memory 1904, and a communication interface 1905.

The RAM 1902 is, for example, a volatile memory and provides a working area to the processor 1901. The ROM 1903 is, for example, nonvolatile and stores an OS, pre-installed applications, system data and so forth. The nonvolatile memory 1904 is, for example, a flash memory. For example, the controller storage unit 242 of the controller 104 may include the RAM 1902, the ROM 1903, and the nonvolatile memory 1904. The processor 1901 may operate as the controller controlling unit 241, for example, by reading out a program stored in the ROM 1903 into the RAM 1902 and executing the program.

The communication interface 1905 may be, for example, an NIC. The processor 1901 may couple to a LAN or the like through the communication interface 1905 and transfer data. The communication interface 1905 operates, for example, as the communication interface 243 of the controller 104.

Further, the respective programs according to the embodiments may be installed in advance, for example, in the storage unit 212, the Wi-Fi storage unit 222, the Wi-Gig storage unit 232, and the controller storage unit 242. Alternatively, the programs may be provided by coupling a removable recording medium or may be provided through a network from a program server or the like.

It is to be noted that the hardware configurations described with reference to FIGS. 17 to 19 are exemplary, and the present technology is not limited to them. For example, part or all of the functions of the respective apparatus described hereinabove may be incorporated as hardware in the form of an FPGA or an SoC. It is to be noted that FPGA is an abbreviation of Field Programmable Gate Array, and SoC is an abbreviation of System-on-a-chip.

Several embodiments have been described above. However, the present technology is not limited to the embodiments described above and is to be recognized as including various alterations and alternative forms to the embodiments described above. For example, it may be recognized that the various embodiments may be embodied in modified forms of the components without departing from the spirit and scope thereof. Further, it may be recognized that various modes may be carried out by suitably combining a plurality of components disclosed in the embodiments described above. Furthermore, it may be recognized by those skilled in the art that various modes may be carried out by deleting or replacing several components from among all the components presented in the embodiments or by adding several components to the components presented in the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication apparatus comprising:
a memory; and
a processor coupled to the memory and configured to execute a determination process that includes
measuring an intensity of a first radio wave received from a first relay apparatus that transmits the first radio wave in accordance with a first wireless communication method,
receiving, from the first relay apparatus, an entering notification having setting information indicative of an intensity range in which the communication apparatus under a certain situation is to receive the first radio wave, and
deciding that communication is possible with a second relay apparatus that transmits a second radio wave in accordance with a second wireless communication method when the measured intensity of the first radio wave received from the first relay apparatus indicates a value within the intensity range indicated by the setting information, and
execute an initiation process that includes
starting, when the processor decides that communication is possible with the second relay apparatus, detection of the second radio wave from the second relay apparatus.

2. The communication apparatus according to claim 1,
wherein the first relay apparatus transmits the first radio wave using beam forming, and
the entering notification is received by the communication apparatus when a transmission direction of a beam transmitted by the first relay apparatus to the communication apparatus is a given direction.

3. The communication apparatus according to claim 2,
wherein the given direction is a direction corresponding to an installation position of the second relay apparatus, and the intensity range indicated by the setting information corresponds to a communication area of the second relay apparatus.

4. The communication apparatus according to claim 1,
wherein the processor is configured to execute a transmission process that includes
transmitting communication period intensity information to the first relay apparatus, the communication period intensity information including a maximum value and a minimum value of the intensity of the first radio wave received from the first relay apparatus measured within a period in which the communication apparatus establishes a communication link with the second relay apparatus.

5. The communication apparatus according to claim 1,
wherein the processor is configured to
execute a reservation process that includes transmitting a download reservation notification to a management apparatus through the first relay apparatus within a period in which the communication apparatus communicates with the first relay apparatus, the download reservation notification being a notification for reserving downloading of data to the management apparatus, the management apparatus being an apparatus that manages the first relay apparatus and the second relay apparatus, and
execute, when the entering notification is received, an instruction process that includes instructing the management apparatus to transfer the data to the second relay apparatus through the first relay apparatus.

6. A detection method executed by a processorof a communication apparatus, the method comprising:
executing, by the processor, a determination process that includes
measuring an intensity of a first radio wave received from a first relay apparatus that transmits the first radio wave in accordance with a first wireless communication method,
receiving, from the first relay apparatus, an entering notification having setting information indicative of an intensity range in which the communication apparatus under a certain situation is to receive the first radio wave, and
deciding that communication is possible with a second relay apparatus that transmits a second radio wave in accordance with a second wireless communication method when the measured intensity of the first radio wave received from the first relay apparatus indicates a value within the intensity range indicated by the setting information; and
executing, by the processor, an initiation process that includes
starting, when the processor decides that communication is possible with the second relay apparatus, detection of the second radio wave from the second relay apparatus.

7. The detection method according to claim 6,
wherein the first relay apparatus transmits the first radio wave using bean forming, and
the entering notification is received by the communication apparatus when a transmission direction of a beam transmitted by the first relay apparatus to the communication apparatus is a given direction.

8. The detection method according to claim 7,
wherein the given direction is a direction corresponding to an installation position of the second relay apparatus and the intensity range indicated by the setting information corresponds to a communication area of the second elay apparatus.

9. The detection method according to claim 6, the method further comprising:
executing, by the processor, a transmission process that includes
transmitting communication period intensity information to the first relay apparatus, the communication period intensity information including a maximum value and a minimum value of the intensity of the radio wave received from the first relay apparatus measured within a period in which the communication apparatus establishes a communication link with the second relay apparatus.

10. The detection method according to claim 6, the method further comprising:
executing, by the processor, a reservation process that includes transmitting a download reservation notification to a management apparatus through the first relay apparatus within a period in which the communication apparatus communicates with the first relay apparatus, the download reservation notification being a notification for reserving downloading of data to the management apparatus, the management apparatus being an apparatus that manages the first relay apparatus and the second relay apparatus, and
executing, by the processor, when the entering notification is received, an instruction process that includes instructing the management apparatus to transfer the data to the second relay apparatus through the first relay apparatus.

11. A communication system, comprising:
a communication apparatus configured to communicate using a first wireless communication method and a second wireless communication method;
a first relay apparatus configured to transmit a first radio wave in accordance with the first wireless communication method using beam forming; and
a second relay apparatus configured to transmit a second radio wave in accordance with the second wireless communication method,
wherein the first relay apparatus includes
a memory, and
a processor coupled to the memory and configured to
execute an entering notification process that includes transmitting an entering notification to the communication apparatus when a transmission direction of a beam of the beam forming is a direction corresponding to an installation position of the second relay apparatus in communication with the communication apparatus, the entering notification having setting information indicative of an intensity range in which the communication apparatus under a certain situation is to receive the first radio wave from the first relay apparatus, and
the communication apparatus includes
a memory, and
a processor coupled to the memory and configured to
execute a determination process that includes
measuring an intensity of the first radio wave received from the first relay apparatus that transmits the first radio wave in accordance with the first wireless communication method,
receiving, from the first relay apparatus, the entering notification having the setting information indicative of the intensity range, and
deciding that communication is possible with the second relay apparatus that transmits the second radio wave in accordance with the second wireless communication method when the measured intensity of the first radio wave received from the first relay apparatus indicates a value within the intensity range indicated by the setting information, and
execute an initiation process that includes
starting, when the processor decides that communication is possible with the second relay apparatus, detection of the second radio wave from the second relay apparatus.

12. The communication system according to claim 11,
wherein the first relay apparatus transmits the first radio wave using beam forming, and
the entering notification is received by the communication apparatus when a transmission direction of a beam transmitted by the first relay apparatus to the communication apparatus is a given direction.

13. The communication system according to claim 12,
wherein the given direction is a direction corresponding to an installation position of the second relay apparatus, and the intensity range indicated by the setting information corresponds to a communication area of the second relay apparatus.

14. The communication system according to claim 11,
wherein the processor is configured to execute a transmission process that includes
transmitting communication period intensity information to the first relay apparatus, the communication period intensity information including a maximum value and a minimum value of the intensity of the first radio wave received from the first relay apparatus measured within a period in which the communication apparatus establishes a communication link with the second relay apparatus.

15. The communication system according to claim 11,
wherein the processor is configured to
execute a reservation process that includes transmitting a download reservation notification to a management apparatus through the first relay apparatus within a period in which the communication apparatus communicates with the first relay apparatus, the download reservation notification being a notification for reserving downloading of data to the management apparatus, the management apparatus being an apparatus that manages the first relay apparatus and the second relay apparatus, and
execute, when the entering notification is received, an instruction process that includes instructing the management apparatus to transfer the data to the second relay apparatus through the first relay apparatus.
